(19) United States
(12) Patent Application Publication
(10) Pub. No.: US 2017/0371830 A1
(43) Pub. Date: Dec. 28, 2017

(54) ACCELERATED I3C MASTER STOP

(71) Applicant: QUALCOMM Incorporated, San Diego, CA (US)

(72) Inventor: Radu Pitigoi-Aron, San Jose, CA (US)

(21) Appl. No.: 15/633,658

(22) Filed: Jun. 26, 2017

Related U.S. Application Data
(60) Provisional application No. 62/355,870, filed on Jun. 28, 2016.
(60) Provisional application No. 62/524,464, filed on Jun. 23, 2017.

(51) Int. Cl. G06F 13/42; H04B 1/58

(52) U.S. Cl. CPC G06F 13/4282; H04B 1/58

(57) ABSTRACT

Systems, methods, and apparatus for communication over to serial bus in accordance with an I3C protocol are described. A method performed at a master device includes causing a line driver to enter a high-impedance mode of operation, and receiving data from the serial bus. When a data line of the serial bus is in a high voltage state while a last bit of a data byte is being transmitted, the line may be configured for an open-drain mode of operation, and transmitting a START condition on the serial bus while the last bit of the data byte is being transmitted. When a plurality of data bytes is sequentially transmitted with last bits that cause a low voltage state, the line may be configured for an open-drain mode of operation, and transmitting a START condition on the serial bus after the last bit of the data byte is being transmitted

### CROSS-REFERENCE TO RELATED APPLICATIONS

This application claims priority to and the benefit of Provisional Patent Application No. 62/355,870 filed in the U.S. Patent Office on Jun. 28, 2016 and Provisional Patent Application No. 62/524,464 filed in the U.S. Patent Office on Jun. 23, 2017, the entire content of which applications are incorporated herein by reference below in their entirety and for all applicable purposes.

### TECHNICAL FIELD

The present disclosure relates generally to an interface between processors and peripheral devices and, more particularly, to improving control of a serial bus adapted to permit communication between devices.

### BACKGROUND

Certain devices, such as mobile communication devices, include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. The I3C bus are defined by the Mobile Industry Processor interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. Certain protocols employed in I3C implementations can increase available bandwidth on the serial bus using higher transmitter clock rates, by encoding data in signaling state of two or more wires, and/or through other encoding techniques. Certain aspects of the I3C protocol are derived from corresponding aspects of the I2C protocol, and the I2C and I3C protocols can coexist on the same serial bus.

There is a continuous demand for increased performance of serial buses, and there exists an ongoing need for providing improved signaling and optimization of protocols used in I3C protocols and the like.

### SUMMARY

Certain aspects of the disclosure relate to systems, apparatus, methods and techniques that optimize throughput on a serial bus that may be operated in multiple modes of communication. In one example, techniques are disclosed that provide a master device on an I3C bus with the ability to accelerate a STOP condition when reading data from a slave device coupled to the I3C bus.

In various aspects of the disclosure, a method performed at a slave device coupled to the serial bus includes enabling a line driver to actively drive a first wire of the serial bus, transmitting a data byte on the first wire when the line driver is enabled to actively drive the first wire, disabling the line driver from actively driving the first wire while transmitting a last bit of the data byte when the last bit of the data byte causes the first wire to be in a high voltage state, and disabling the line driver from actively driving the first wire after transmitting the last bit of the data byte when the data byte is the Nth successive byte transmitted with a last bit that causes the first wire to be in a low voltage state. The first wire may be passively held in the high voltage state when the line driver is disabled.

In one aspect, N is greater than 1. In one example, the line driver is disabled from actively driving the first wire after four sequentially-transmitted bytes each have a last bit that causes the first wire to be in the low voltage state.

In one aspect, disabling the line driver from actively driving the first wire includes causing an output of the line driver to present a high-impedance to the first wire. Disabling the line driver from actively driving the first wire may include configuring an output of the line driver for an open-drain mode of operation.

In one aspect, enabling the line driver to actively drive the first wire includes configuring an output of the line driver for a push-pull mode of operation.

In one aspect, the method includes receiving a command to enter an I3C mode of operation prior to enabling the line driver to actively drive the first wire and exiting the I3C mode of operation after disabling the line driver from actively driving the first wire. The method may include identifying an I2C repeated start condition in signaling on the serial bus after disabling the line driver from actively driving the first wire, re-enabling the line driver to actively drive the first wire after identifying the I2C repeated start condition, and transmitting a further data byte on the first wire after the line driver is re-enabled.

In one aspect, the data byte is transmitted while the serial bus is operated in accordance with an I3C protocol.

In various aspects, an apparatus may be adapted to operate as a slave device when coupled to a serial bus. The apparatus may include a line driver having an output configurable for a plurality of modes of operation, and a processing device. The processing device may be adapted to enable the output of the line driver to actively drive a first wire of the serial bus after an I2C start condition is detected on the serial bus, transmit one or more data bytes on the first wire when the line driver is enabled, disable the output of the line driver while a last bit of the data byte is being transmitted and when the last bit of the data byte causes the first wire to be in a high voltage state, and disable the line driver from actively driving the first wire after transmitting the last bit of the data byte when the data byte is the Nth successive byte transmitted with a last bit that causes the first wire to be in a low voltage state. The first wire may be passively held in the high voltage state until transmission of the last bit of the data byte is completed. The apparatus may include a pull-up resistor the first wire in the high voltage state when the output of the line driver is disabled.

In one aspect, N is greater than 1.

In one aspect, the processing device is adapted to disabling the line driver from actively driving the first wire after four sequentially-transmitted bytes each have a last bit that causes the first wire to be in the low voltage state. The apparatus may present a high-impedance to the first wire when the output of the line driver is disabled. The line driver may be operable as an open-drain driver.

In one example, the processing device is adapted to identify an I2C repeated start condition in signaling on the serial bus after disabling the line driver, re-enable the line driver after identifying the I2C repeated start condition, and transmit a further data byte on the first wire after the line driver is re-enabled.

In various aspects, a processor-readable storage medium includes code, instructions, and/or data. The code, when executed by one or more processors may cause the one or more processors to enable a line driver to actively drive a first wire of the serial bus, transmit a data byte on the first wire when the line driver is enabled to actively drive the first wire, disable the line driver from actively driving the first wire while transmitting a last bit of the data byte when the last bit of the data byte causes the first wire to be in a high voltage state, and disable the line driver from actively driving the first wire after transmitting the last bit of the data byte when the data byte is the Nth successive byte transmitted with a last bit that causes the first wire to be in a low voltage state. The first wire may be passively held in the high voltage state when the line driver is disabled.

In one aspect, N is greater than 1. For example, the line driver is disabled from actively driving the first wire after four sequentially-transmitted bytes each have a last bit that causes the first wire to be in the low voltage state.

In one aspect, the code causes the one or more processors to cause an output of the line driver to present a high-impedance to the first wire. The line driver may be disabled from actively driving the first wire by configuring an output of the line driver for an open-drain mode of operation.

In one aspect, the line driver may be enabled to actively drive the first wire by configuring an output of the line driver for a push-pull mode of operation.

In one aspect, the code causes the one or more processors to receive a command to enter air I3C mode of operation prior to enabling the line driver to actively drive the first wire. Exiting the I3C mode of operation after disabling the line driver from actively driving the first wire. The code causes the one or more processors to identify an I2C repeated start condition in signaling on the serial bus after disabling the line driver from actively driving the first wire, re-enable the line driver to actively drive the first wire after identifying the I2C repeated start condition, and transmit a further data byte on the first wire after the line driver is re-enabled.

In one aspect, the data byte is transmitted while the serial bits is operated in accordance with an I3C protocol.

In various aspects of the disclosure, a method performed at a master device coupled to a serial bus includes disabling a line driver coupled to a first wire of the serial bus, such that an output of the line driver presents a high-impedance to the first wire, receiving a data byte from the first wire while the line driver is disabled, enabling the line driver to actively drive the first wire after receiving a last bit of the data byte and when the last bit causes the first wire to be in a high voltage state or when the data byte is the Nth sequentially-received data byte that has a last bit that causes the first wire to be in a low voltage state, and transmit a start condition defined by an I2C protocol after the line driver is enabled to actively drive the first wire.

In certain aspects, the method includes extending timing of a clock signal transmitted on a second wire of the serial bus prior to enabling the line driver. Extending timing of the clock signal includes extending a clock pulse on a second wire of the serial bus. The clock pulse may be transmitted concurrently with the last bit of the data byte. In one example, the start condition may include a portion of the last bit of the data byte. In another example, the repeated START condition includes a portion of clock that is used for a flow control bit.

In one aspect, the line driver is enabled after transmitting a sequence of four bytes that each have a last bit that causes the first wire to be in the low voltage state.

In one aspect, the method includes transmitting a stop condition defined by the I2C protocol on the serial bus after transmitting the start condition. The method may include transmitting a command that causes a slave device to enter an I3C mode of operation. The data byte may be received while the serial bus is operated in accordance with an I3C protocol.

In various aspects of the disclosure, an apparatus adapted to operate as a master device when coupled to a serial bus includes a line driver having an output configurable for a plurality of modes of operation, and a processing device. The processing device may be adapted to transmit a first I2C start condition on the serial bus and configure the output of the line driver for a first mode of operation after the first I2C start condition has been transmitted on the serial bus. The processing device may be adapted to disable the line driver may from actively driving a first wire of the serial bus when the output of the line driver is configured for the first mode of operation, receive a data byte from the first wire when the output of the line driver is configured for the first mode of operation, configure the output of the line driver for a second mode of operation of while a last bit of the data byte causes the first wire to be in a high voltage state or after the last bit when the data byte is the Nth sequentially-received data byte that has a last bit that causes the first wire to be in a low voltage state, and transmit a second start condition. The second start condition may be a repeated start condition and may include signaling corresponding to the last bit of the data byte. The line driver may actively drive the first wire when the output of the line driver is configured for the second mode of operation. The first wire may be passively held in the high voltage state until the last bit of the data. byte is received.

In one aspect, the processing device is adapted to extend timing of a clock signal transmitted on a second wire of the serial bus prior to enabling the line driver. The processing device may be adapted to extend a clock pulse on a second wire of the serial bus. The clock pulse may be transmitted after the last bit of the data byte.

In one aspect, the line driver may be enabled after transmitting a sequence of four bytes that each have a last bit that causes the first wire to be in the low voltage state. The start condition may include a portion of the last bit of the data byte. An output of the line driver may operate as an open-drain driver in the second mode of operation.

In one aspect, the processing device is adapted to transmit a stop condition defined by an I2C protocol on the serial bus after the second start condition. The processing device may be adapted to transmit a command that causes a slave device to transmit data in accordance with an I3C protocol.

In various aspects, a processor-readable storage medium includes code, instructions, and/or data. The code, when executed by one or more processors, may cause the one or more processors to transmit a first I2C start condition on the serial bus, configure the output of the line driver for a first mode of operation after the first I2C start condition has been transmitted on the serial bus. The code may cause the one or more processors to disable the line driver from actively driving a first wire of the serial bus when the output of the line driver is configured for the first mode of operation, receive a data byte from the first wire when the output of the line driver is configured for the first mode of operation, configure the output of the line driver for a second mode of operation of while a last bit of the data byte causes the first wire to be in a high voltage state or after the last bit when the data byte is the Nth sequentially-received data byte that has a last bit that causes the first wire to be in a low voltage state, and transmit a second start condition. The second start condition may be a repeated start condition and may include signaling corresponding to the last bit of the data byte. The line driver may actively drive the first wire when the output of the line driver is configured for the second mode of operation. The first wire may be passively held in the high voltage state until the last bit of the data byte is received.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a configuration of devices coupled to a common serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a data word sent to a slave device in accordance with I3C protocols.

FIG. 7 illustrates an example of the timing associated with a data read from a slave device in accordance with I3C protocols.

FIG. 8 illustrates a first example in which a bus master ends a read transaction early by emitting a repeated START condition, followed by a STOP condition in accordance with certain aspects disclosed herein.

FIG. 9 illustrates a second example in which a bus master ends a read transaction early by emitting a repeated START condition and continues with a different data transfer in accordance with certain aspects disclosed herein.

FIG. 10 illustrates a third example in which a bus master ends a read transaction early by emitting a repeated START condition, followed by a STOP condition in accordance with certain aspects disclosed herein.

FIG. 11 illustrates a fourth example in which a bus master ends a read transaction early by emitting a repeated START condition and continues with a different data transfer in accordance with certain aspects disclosed herein.

FIG. 12 illustrates a first example of an operation in which a master device forgoes an opportunity to transmit a repeated START condition in accordance with certain aspects disclosed herein.

FIG. 13 illustrates a second example of an operation in which a master device forgoes an opportunity to transmit a repeated START condition in accordance with certain aspects disclosed herein.

FIG. 14 illustrates a third example of an operation in which a master device forgoes an opportunity to transmit a repeated START condition in accordance with certain aspects disclosed herein.

FIG. 15 is a block diagram illustrating an example of an apparatus employing a processing circuit that may be adapted according to certain aspects disclosed herein.

FIG. 16 is a flowchart illustrating certain operations of a slave device coupled to a serial bus and configured in accordance with certain aspects disclosed herein.

FIG. 17 illustrates an example of a hardware implementation for an apparatus adapted in accordance with certain aspects disclosed herein.

FIG. 18 is a flowchart illustrating certain operations of a master device coupled to a serial bus and configured in accordance with certain aspects disclosed herein.

FIG. 19 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoCs and/or other IC devices often employ a serial bus to connect processors with modems and other peripherals. The serial bus may be operated in accordance with specifications and protocols defined by a standards body. In one example, the serial bus may be operated in accordance I3C protocols, which define timing relationships between signals and transmissions that enable devices limited to communicating in accordance with I2C protocols to coexist on a serial bus with devices that communicate in accordance with I3C protocols. According to various aspects of the disclosure, a master device may be configured to advance a repeated START condition and/or STOP condition while reading data from a slave device.

In one example, a master device coupled to the serial bus may cause a line driver to enter a high-impedance mode of operation before receiving data from the serial bus. The master device may advance the timing of a repeated START condition when the last bit of the data received from the serial bus cause the data line of the serial bus to be in a high voltage state. The slave device may be configured to enter a high-impedance mode of operation or an open-drain mode of operation when a data line of the serial bus is in a high voltage state during the last bit of a data byte transmitted on the bus, allowing the master device to drive the data line before the last bit has been completely transmitted. The master device may then provide a repeated START condition on the serial bus that commences during the time allocated for transmission of the last bit.

In another example, a master device coupled to the serial bus may cause a line driver to enter a high-impedance mode of operation before receiving data from the serial bus. The master device may advance the timing of a repeated START condition when the last bit of the data received from the serial bus cause the data line of the serial bus to be in a high voltage state. The slave device may be configured to enter a high-impedance mode of operation or an open-drain mode of operation when a data line of the serial bus is in a high voltage state during the last bit of a data byte transmitted on the bus, allowing the master device to drive the data line before the last bit has been completely transmitted. The master device may then provide a repeated START condition on the serial bus that commences during the time allocated for transmission of the last bit.

Example of an Apparatus with a Serial Disk Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

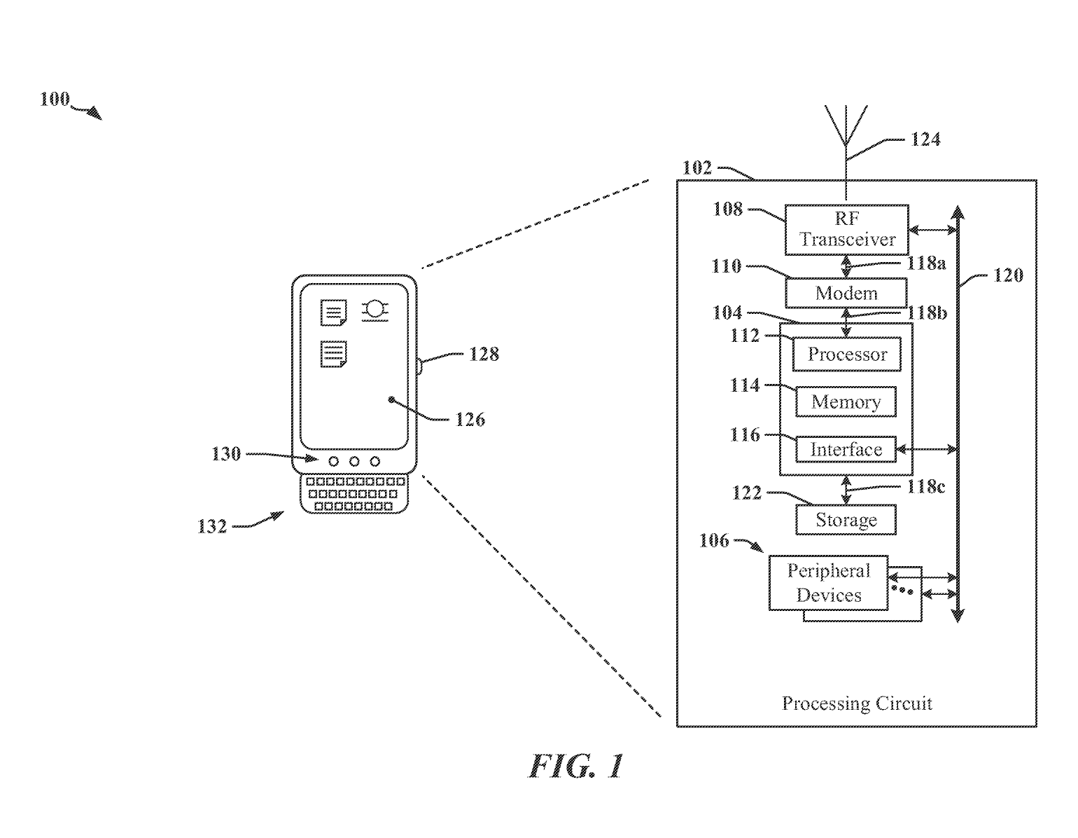

FIG. 1 illustrates an example of an apparatus 100 that may employ a data communication bus. The apparatus 100 may include a processing circuit 102 having multiple circuits or devices 104, 106, 108 and/or 110, which may be implemented in one or more ASICs and/or one or more SoCs. In one example, the apparatus 100 may be a communication device and the processing circuit 102 may include ASIC 104 that includes a processor 112. The ASIC 104 may implement or function as a host or application processor. The apparatus 100 may include one or more peripheral devices 106, one or more moderns 110 and a transceiver 108 that enables the apparatus to communicate through an antenna 124 with a radio access network, a core access network, the Internet and/or another network. The configuration and location of the circuits or devices 104, 106, 108, 110 may vary between applications.

The circuits or devices 104, 106, 108, 110 may include a combination of sub-components. In one example, the ASIC 104 may include more than one processors 112, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 118c, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

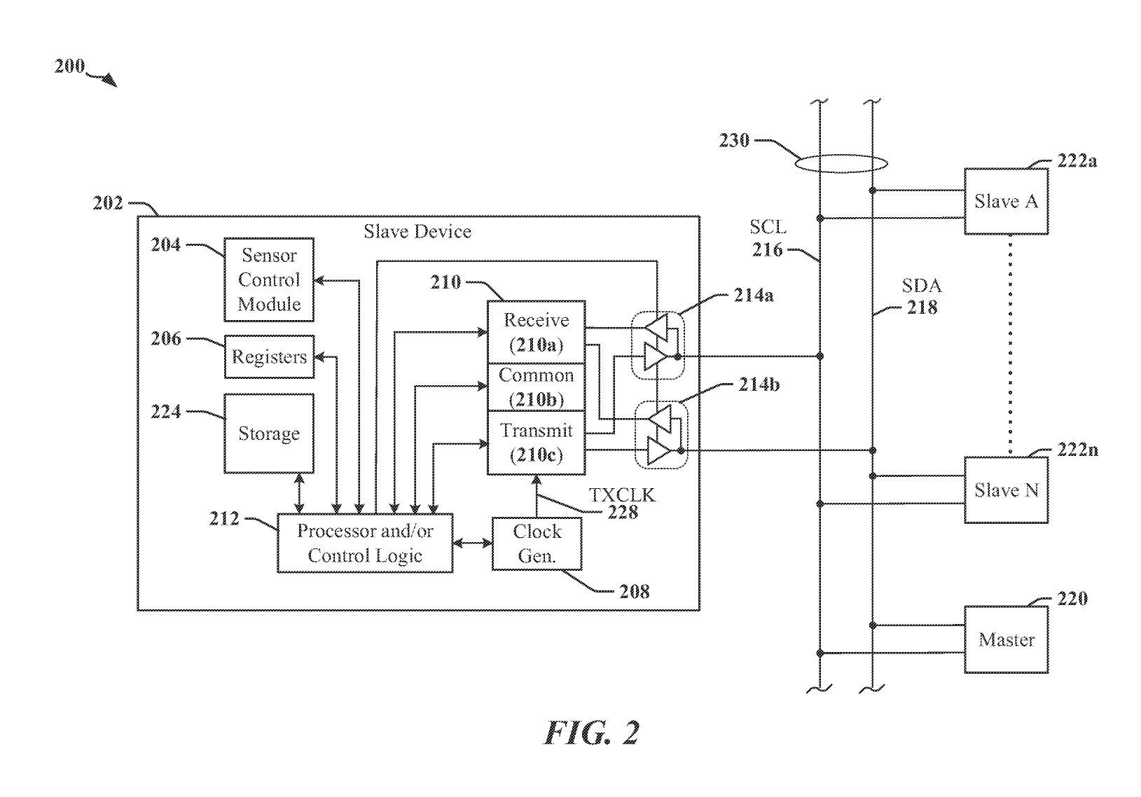

FIG. 2 illustrates certain aspects of an apparatus 200 that includes multiple devices 202, 220 and 222a-222n connected to a serial bus 230. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain types of bus can support multiple bus masters 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a sensor control function 204. The sensor control function 204 may include circuits and modules that support an image sensor, and/or circuits and modules that control and communicate with one or more sensors that measure environmental conditions. The slave device 202 may include configuration registers or other storage 206, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing provided by a clock generation circuit 208.

Two or more of the devices 202, 220 and/or 222a-222n may be adapted according to certain aspects and features disclosed herein to support a plurality of different communication protocols over a common bus, which may include the I2C protocol, and/or the I3C protocol. In some instances, devices that communicate using the I2C protocol can coexist on the same 2-wire interface with devices that communicate using I3C protocols, In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de factor I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals, transmitted on the serial bus 230.

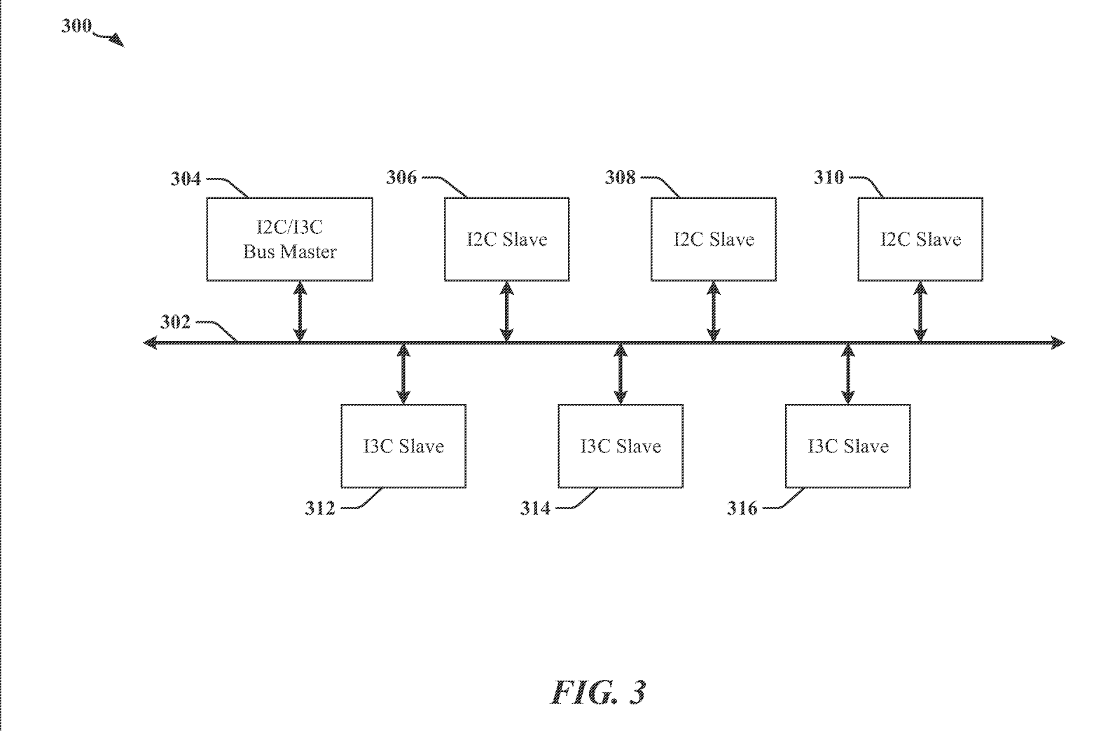

FIG. 3 illustrates a system 300 having a configuration of devices 304, 306, 308, 310, 312, 314 and 316 connected to a serial bus 302, whereby I3C devices 304, 312, 314 and 316 may be adapted or configured to obtain higher data transfer rates over the serial bus 302 using I3C protocols. The I3C devices 304, 312, 314 and 316 may coexist with conventionally configured I2C devices 306, 308, and 310. The I3C devices 304, 312, 314 and 316 may alternatively or additionally communicate using conventional I2C protocols, as desired or needed.

The serial bus 302 may be operated at higher data transfer rates when a master device 304 operates as an I3C bus master when controlling the serial bus 302. In the depicted example, a single master device 304 may serve as a bus master in I2C mode and in an I3C mode that supports a data transfer rate that exceeds the data transfer rate achieved when the serial bus 302 is operated according to a conventional I2C protocol. The signaling used for higher data-rate traffic may take advantage of certain features of I2C protocols such that the higher data-rate traffic can be carried over the serial bus 302 without compromising the functionality of legacy I2C devices 306, 308, 310 and 312 coupled to the serial bus 302.

Timing in an I2C Bus

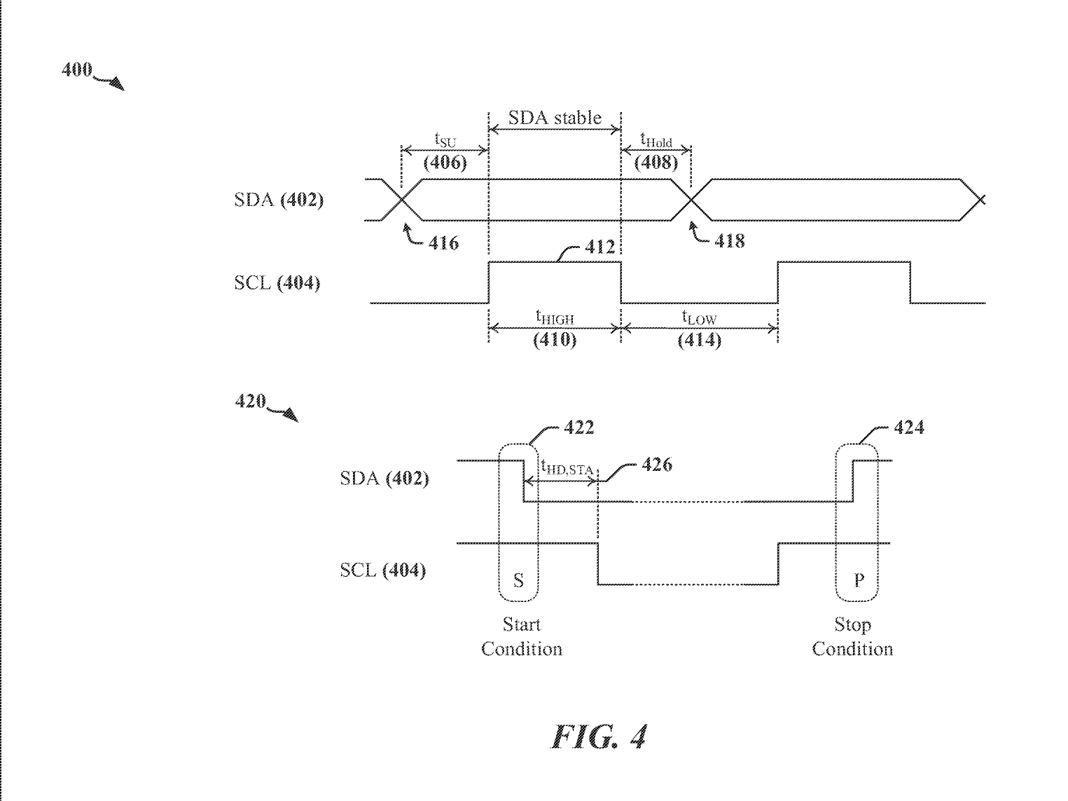

FIG. 4 includes timing diagrams 400 and 420 that illustrate the relationship between the SDA wire 402 and the SCL wire 404 on a conventional I2C bus. The first timing diagram 400 illustrates the timing relationship between the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

Specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a conventional I2C bus. The I2C protocol provides for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A START condition 422 is defined to permit the current bus master to signal that data is to be transmitted. The START condition 422 occurs when the SDA wire 402 transitions from high to low while the SCL wire 404 is high. The I2C bus master initially transmits the START condition 422, which may be also be referred to as a start bit, followed by a 7-bit address of an I2C slave device with which it wishes to exchange dat. The address is followed by a single bit that indicates whether a read or write operation is to occur. The addressed I2C slave device, if available, responds with an ACK bit. If no I2C slave device responds, the I2C bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a STOP condition 424 is transmitted by the I2C master device. The STOP condition 424 occurs when the SDA wire 402 transitions from low to high while the SCL wire 404 is high. The I2C Specifications require that all transitions of the SDA wire 402 occur when the SCL wire 404 is low, and exceptions may be treated as a START condition 422 or a STOP condition 424.

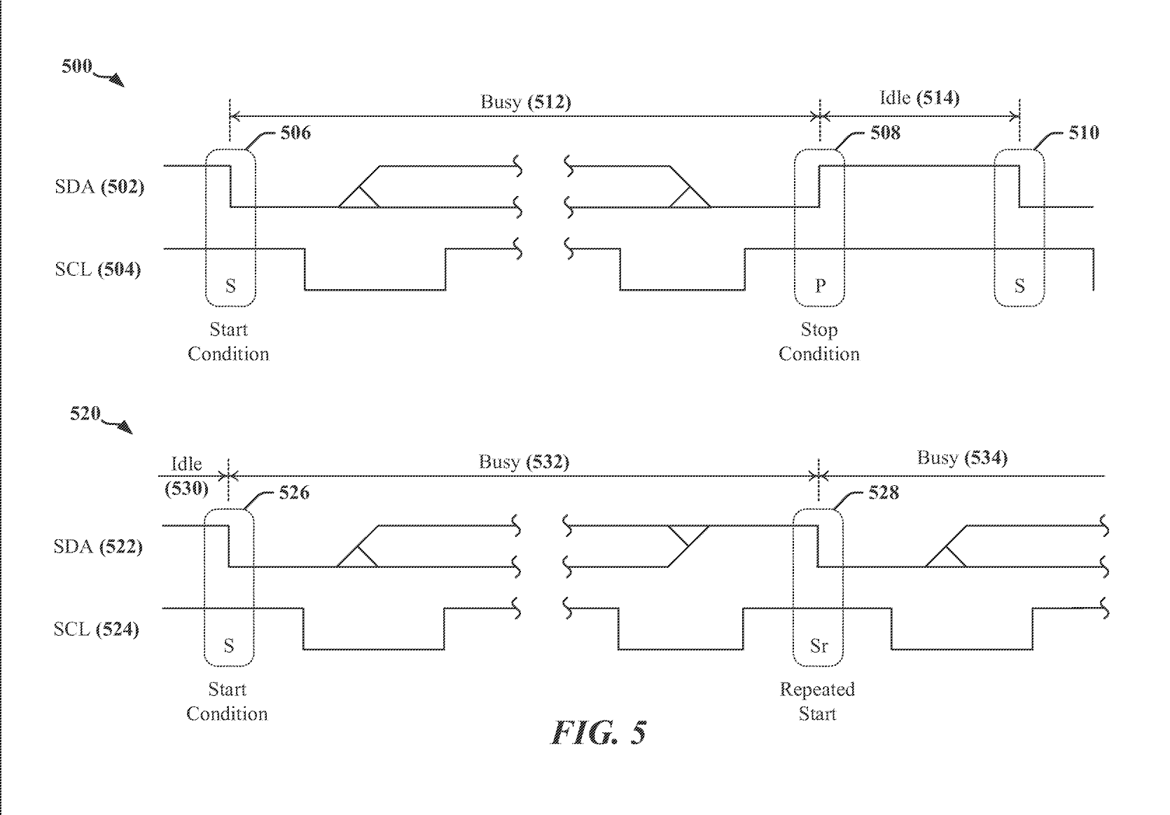

FIG. 5 includes diagrams 500 and 520 that illustrate timing associated with data transmissions on an I2C bus. As illustrated in the first diagram 500, an idle period 514 may occur between a STOP condition 508 and a consecutive START condition 510. This idle period 514 may be prolonged, and may result in reduced data throughput when the conventional I2C bus remains idle between the STOP condition 508 and the consecutive START condition 510. In operation, a busy period 512 commences when the I2C bus master transmits a first START condition 506, followed by data. The busy period 512 ends when the I2C bus master transmits a STOP condition 508 and the idle period 514 ensues. The idle period 514 ends when a second START condition 510 is transmitted.

The second timing diagram 520 illustrates a method by which the number of occurrences of an idle period 514 may be reduced. in the illustrated example, data is available for transmission before a first busy period 532 ends. The I2C bus master device may transmit a repeated START condition 528 (Sr) rather than a STOP condition. The repeated START condition 528 terminates the preceding data transmission and simultaneously indicates the commencement of a next data transmission. The state transition on the SDA wire 522 corresponding to the repeated START condition 528 is identical to the state transition on the SDA wire 522 for a START condition 526 that occurs after an idle period 530. For both the START condition 526 and the repeated START condition 528, the SDA wire 522 transitions from high to low while the SCL wire 524 is high. When a repeated START condition 528 is used between data transmissions, a first busy period 532 is immediately followed by a second busy period 534.

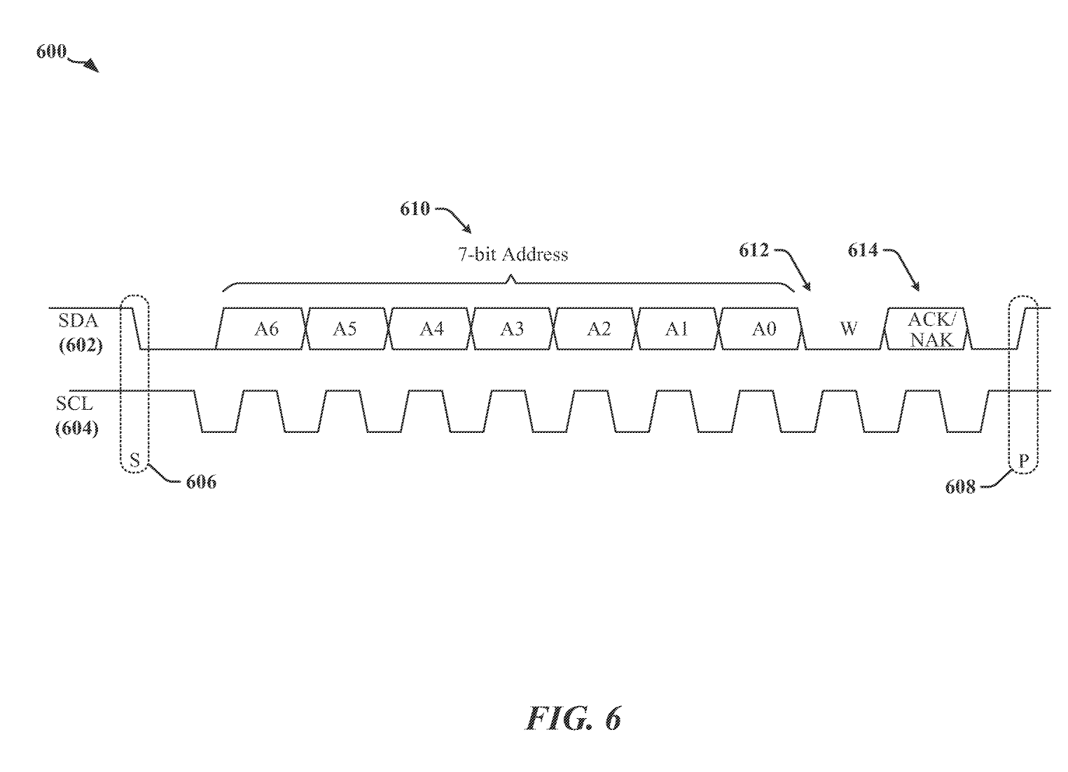

FIG. 6 is a diagram 600 that illustrates an example of the timing associated with a command word sent to a slave device in accordance with I2C protocols. In the example, a master device initiates the transaction with a START condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a HACK. The master device may terminate the transaction with a STOP condition 608 by driving the SDA wire 602 from low to high while the SCL wire 604 is high. This transaction can be used to determine whether a slave device with the transmitted address coupled to the I2C bus is in an active state.

The master device relinquishes control of the SDA wire 602 after transmitting the Write/Read command bit 612 such that the slave device may transmit an acknowledgment (ACK) bit on the SDA wire 602. In some implementations, open-drain drivers are used to drive the SDA wire 602. When open-drain drivers are used, the SDA drivers in the master device and the slave device may be active concurrently. In other implementations, push-pull drivers are used to drive the SDA wire 602. When push-pull drivers are used, the signaling state of the SDA wire 602 may be indeterminate when the SDA drivers in both the master device and the slave device are active concurrently.

Timing in An I3C Bus

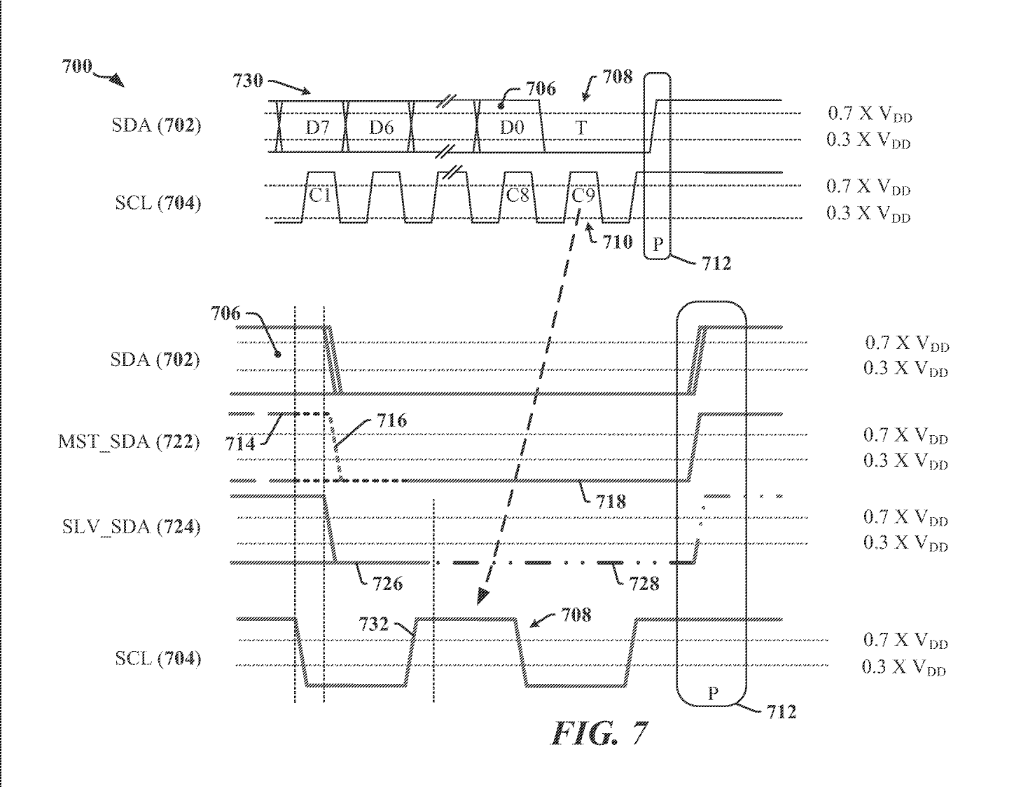

FIG. 7 is a diagram 700 that illustrates an example of the timing associated with a data read from a slave device in accordance with I3C protocols. In the example, a master device provides a clock signal (SCL 704) on a first wire that controls timing of a data signal (SDA 702) transmitted on a second wire. SDA 702 can be bidirectional where, data can be transmitted from a master device to a slave device in a first transaction, or from a slave device to a master device in a second transaction. Certain I3C devices may include drivers that drive SDA 702 in open-drain and push-pull modes. In open-drain mode, the drivers can tolerate concurrent driving of the SDA wire 602 by bus and master devices. In certain modes of operation, the I3C device drivers are operated in push-pull mode and the master device and the slave device generally cannot drive SDA 702 concurrently.

The I3C protocol provides for turnaround as illustrated in FIG. 7. The mode of operation of the line driver in the master device that is coupled to SDA 702 is illustrated in the first timeline 722. During transmission of a data byte 730 by the slave device, the line driver in the master device is in a high-impedance mode 714 and does not create any conflicts with the corresponding driver of the slave device. As the last bit 706 of the data byte 730 is being transmitted by the slave device, the line driver of the master device enters an open-drain mode 716 before actively driving SDA 702 in an active mode 718.

The mode of operation of the line driver in the slave device that is coupled to SDA 702 is illustrated in the second timeline 724. The line driver of the slave device is initially in an active mode 726, driving the last bit 706 of the data byte 730, and before a transition bit 708 (T bit) is driven by the master device. The line driver of the slave device then enters a high impedance mode 728 as the master driver takes control of SDA 702, after the rising edge 732 of a clock pulse 710 used to sample the T bit 708.

In the illustrated example, the master device transmits a transition bit 708 to establish the timing condition required before a STOP condition 712 is transmitted. The master device may alternatively transmit a repeated START condition to continue receiving data from the slave device after the master driver enters the active mode 718.

In some applications, an I3C bus may be used to carry a variety of data traffic between different devices. In some instances, a master device may determine that an exception has occurred that requires termination of a current transaction. The exception may be caused by an error in data transmission, an event detected by a slave device or a master device. The exception may be generated by an application processor. The exception may be related to the availability of priority traffic to be transmitted over the I3C bus. If a bus master is actively transmitting on the I3C bus, then a START condition or repeated START condition may be immediately transmitted to begin a transmission of a command related to the exception. For example, the master device may transmit a START condition or repeated START condition while transmitting a command or a byte of data, and may then issue a command to read or write high-priority data. A slave device that was involved in a transaction prior to the occurrence of the exception recognizes the START condition or repeated START condition and determines that an error has occurred in the current transmission.

If a bus master is reading data from a slave device coupled to the I3C bus using push-pull drivers, then a conventional master device may issue a command related to the exception after the slave device has completed transmission of a current byte and entered high-impedance mode and the master device can transmit a START condition or repeated START condition. The delay between occurrence of an exception and the termination of a read can affect system responsiveness. When open-drain connectors are used, the bus master may interrupt a READ transaction by transmitting a repeated START condition, which causes slave devices to reset their bus interfaces.

Accelerating Stop/Start in an I3Interface

According to certain aspects disclosed herein, a master device that is configured to communicate using push-pull drivers in accordance with I3C protocols and specifications may be adapted to accelerate or force turnaround while reading from a slave device. In a first aspect, acceleration may be accomplished by advancing the transmission of a repeated START condition and/or a STOP condition when the last bit of a data frame or data byte transmitted by the slave is represented by a high voltage level. In a second aspect, acceleration may be accomplished by advancing the transmission of a repeated START condition and/or a STOP condition when the last bit of a data frame or data byte transmitted by the slave is not represented by a high voltage level. In some instances, accelerated turnaround may be employed to terminate a transmission by a slave device before completion of the transmission.

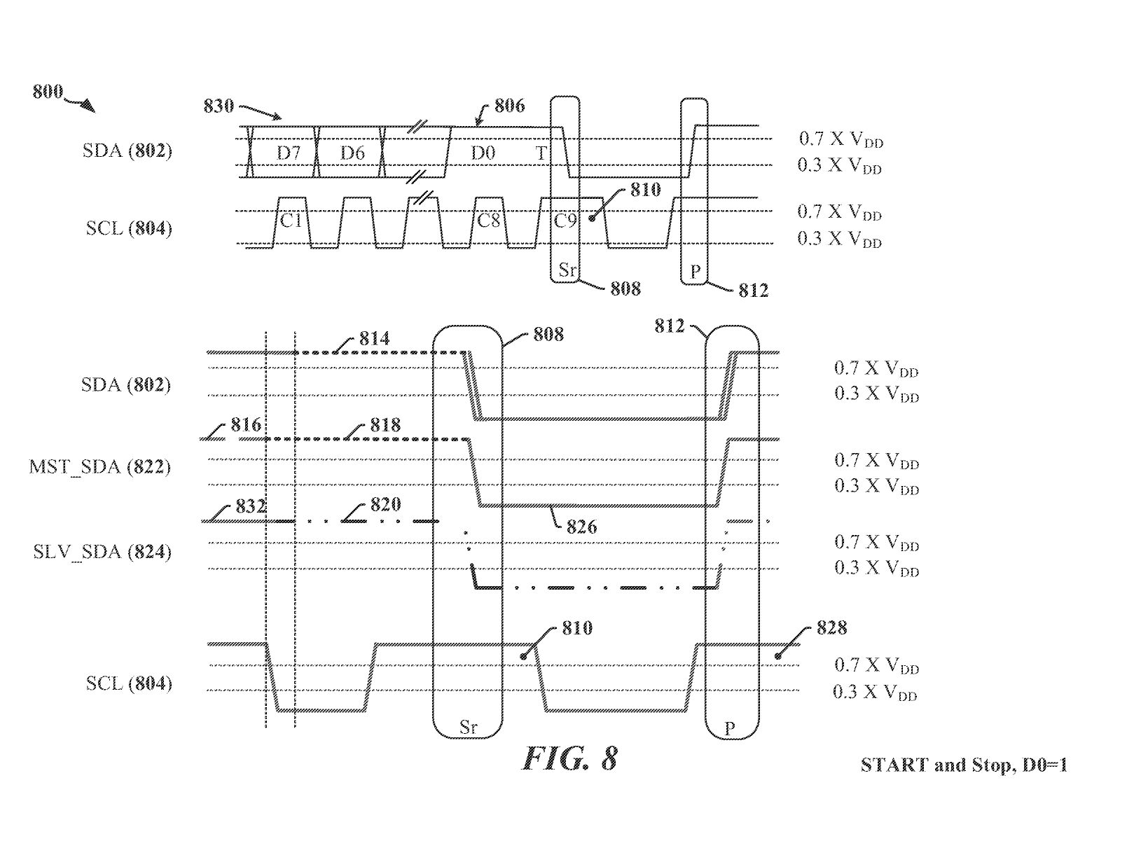

FIG. 8 includes timing diagrams 800 that illustrate a first example in which a repeated START condition 808 may be initiated early. In some instances, the repeated START condition 808 may be asserted to terminate a transaction in which a slave device is transmitting data and may have data remaining to be transmitted. The example illustrated in FIG. 8 may relate to an instance when an exception is detected during transmission of a data frame or data byte 830, and this example may be characterized as a “stop and stop” example. The mode of operation of the line driver in the master device that is coupled to SDA 802 is illustrated in the first timeline 822. During transmission of a data byte 830 by the slave device, the line driver in the master device is in a high-impedance mode 816 and does not create any conflicts with the corresponding driver of the slave device. As the last bit 806 of the data byte 830 is being transmitted by the slave device, the master device recognizes that the SDA 802 is in a high voltage state. The master driver may cause the line driver of the master device to enter an open-drain mode 818 upon detection of the high voltage state corresponding to the last bit 806 of the data byte 830. The master device may actively drive the SDA 802 to a low voltage during the clock pulse 810 corresponding to the Transition (or control) bit that follows the last bit 806 of the data byte 830, upon placing the line driver in an active driving mode 826. The master device may increase the duration of the clock pulse 810 corresponding to the last bit 806 of the data byte 830 to provide adequate setup timing for a repeated START condition 808. During the next clock pulse 828, the master device may transmit a STOP condition 812 to terminate transmissions on the serial bus.

The mode of operation of the line driver in the slave device that is coupled to SDA 802 is illustrated in the second timeline 824. The line driver of the slave device is initially in an active mode 832. When the slave device recognizes that the last bit 806 of the data byte 830 causes SDA 802 to go to a high state, the slave device may cause its driver to enter high impedance mode 820 to permit the master driver the option of takes control of SDA 802. SDA 802 may be pulled high by a termination resistor when the slave device enters high impedance mode 820, and before the master device enters an active driving mode 826. In one example, the termination resistor is an open-drain class pull-up resistor that is coupled to SDA 802 through a switch controlled by the master device.

The master device may enter the open-drain mode 818 (with pull-up) after, or while transmitting a falling edge of SCL 804. The master device may extend the duration of the voltage high state on SCL 804 to comply with timing requirements associated with open-drain mode 818. After a sufficient delay, which is enabled by the extended clock pulse 810, the Master pulls SDA 802 low, thereby providing a repeated START condition (repeated START condition 808). The master device keeps the SDA 802 in the low state for a period of time sufficient to comply with timing requirements associated with open-drain mode 818. After the next rising edge on SCL 804, the master device drives SDA 802 high, providing the STOP condition 812.

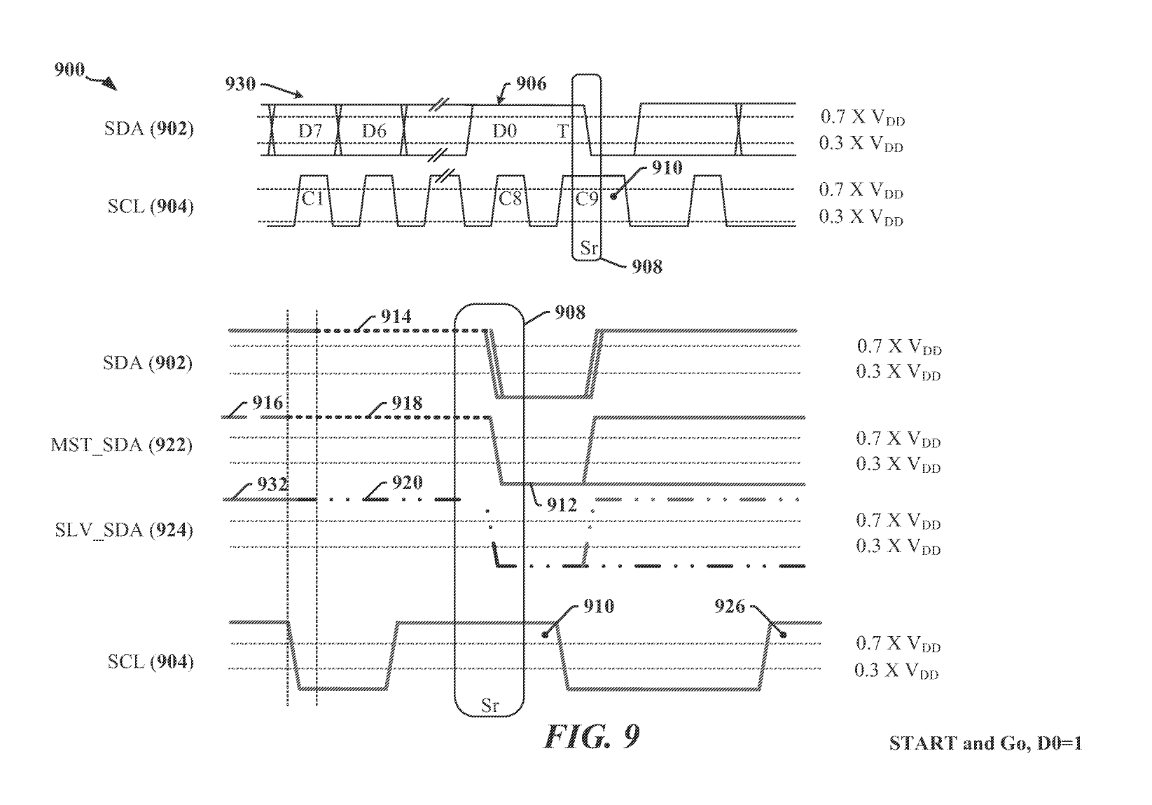

FIG. 9 includes timing diagrams 900 that illustrate a second example in which a repeated START condition 908 may be initiated early. In some instances, the repeated START condition 908 may be asserted to terminate a transaction in which a slave device is transmitting data and may have data remaining to be transmitted. The example illustrated in FIG. 9 may relate to an instance when an exception is detected during transmission of a data frame or data byte 930, and this example may be characterized as a “stop and go” example. The mode of operation of the line driver in the master device that is coupled to SDA 902 is illustrated in the first timeline 922. During transmission of a data byte 930 by the slave device, the line driver in the master device is in a high-impedance mode 916 and does not create any conflicts with the corresponding driver of the slave device. As the last bit 906 of the data byte 930 is being transmitted by the slave device, the master device recognizes that the SDA 902 is in a high voltage state. The master driver may cause the line driver of the master device to enter an open-drain mode 918 upon detection of the high voltage state corresponding to the last bit 906 of the data byte 930. The master device may actively drive the SDA 902 to a low voltage during the clock pulse 910 corresponding to the Transition (or control) bit that follows the last bit 906 of the data byte 930, upon placing the line driver in an active mode 912. The master device may increase the duration of the clock pulse 910 corresponding to the last bit 906 of the data byte 930 to provide adequate setup timing for a repeated START condition 908. On the next clock pulse 926, the master device may begin a new transaction on the serial bus.

The mode of operation of the line driver in the slave device that is coupled to SDA 902 is illustrated in the second timeline 924. The line driver of the slave device is initially in an active mode 932. When the slave device recognizes that the last bit 906 of the data byte 930 causes SDA 902 to go to a high state, the slave device may cause its driver to enter high impedance mode 920 to permit the master driver the option of takes control of SDA 902. SDA 902 may be pulled high by a termination resistor when the slave device enters high impedance mode 920, and before the master device enters an active mode 912. In one example, the termination resistor is implemented using an open-drain class pull-up resistor that is coupled to SDA 902 through a switch controlled by the master device.

In one example, the master device enters the open-drain mode 918 (with pull-up) after, or while transmitting a falling edge of SCL 904. The master device may extend the duration of the voltage high state on SCL 904 to comply with timing requirements associated with open-drain mode 918. After a sufficient delay, which is enabled by the extended clock pulse 910, the master device pulls SDA 902 low, thereby providing a repeated START condition (repeated START condition 908). The master device keeps the SDA 902 in the low state for a period of time sufficient to comply with timing requirements associated with open-drain mode 918. After the falling edge of the clock pulse 910, the master device may drive SDA 902 in accordance with the next data bit that needs to be transmitted. The master device may then provide a rising edge of the next clock pulse on SCL 904.

When the slave device is configured to support accelerated Stop/Start, the slave device enters the high-impedance mode during the last bit transmission period after every byte that terminates with the slave device transmitting a high voltage on the SDA 802, 902. Different modes of communication may be supported by the slave device such that the slave device may enable and disable support for accelerated STOP/START. In one example, the slave device enables a first mode of communication in response to a command received at the slave device, where accelerated STOP/START is supported in the first mode of communication. The slave device may disable the first mode of communication in response to a command received at the slave device. The command may be transmitted by a bus master, application processor or other entity.

The slave device may configure its line driver for a high-impedance mode. In one example, the slave device may gate a transistor of the line driver to cause the output of the line driver to present a high impedance to SDA 802, 902. It will be appreciated that impedance of the SDA 802, 902 may be defined by another device that is not in high-impedance mode.

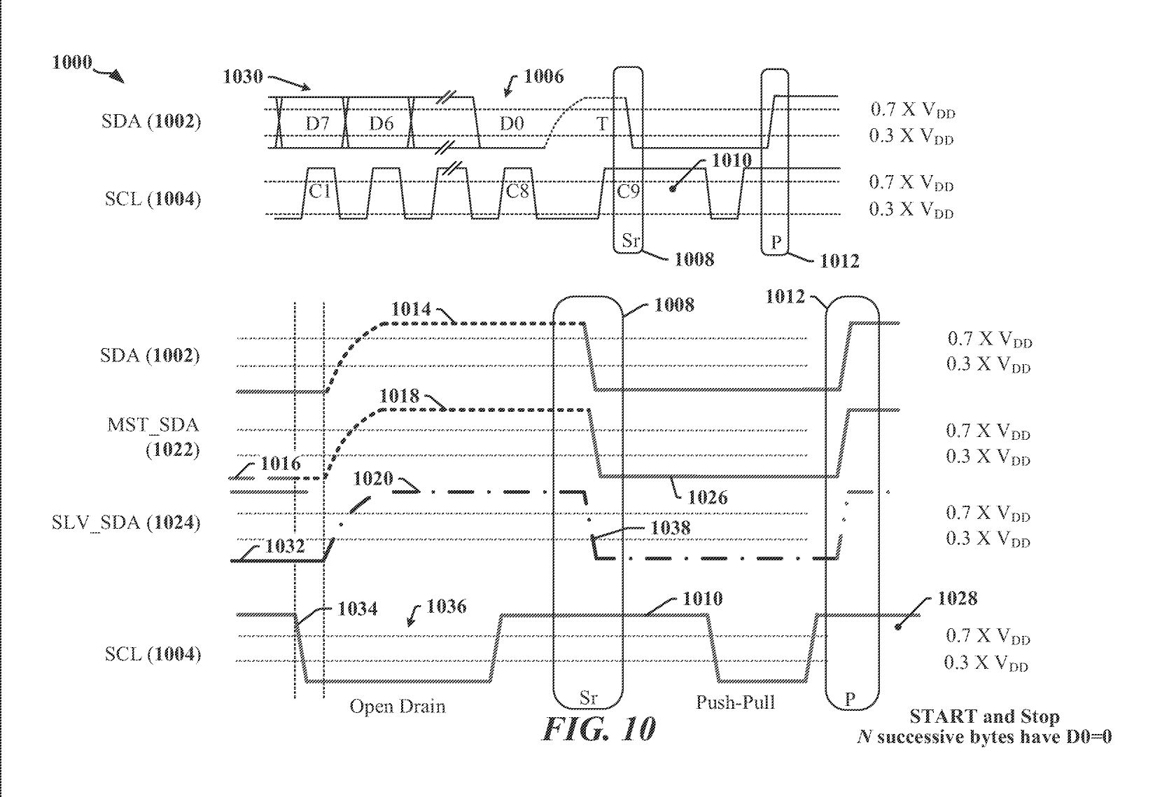

FIG. 10 includes timing diagrams 1000 that illustrate a third example in which a repeated START condition 1008 may be initiated early. in some instances, the repeated START condition 1008 may be asserted to terminate a transaction in which a slave device is transmitting data and may have data remaining to be transmitted. The example illustrated in FIG. 10 may relate to an instance when an exception is detected during transmission of a data frame or data byte 1030, and this example may be characterized as a “stop and stop” example. The mode of operation of the line driver in the master device that is coupled to SDA 1002 is illustrated in the first timeline 1022. During transmission of a data byte 1030 by the slave device, the line driver in the master device is in a high-impedance mode 1016 and does not create any conflicts with the corresponding driver of the slave device. As the last bit 1006 of the data byte 1030 is being transmitted by the slave device, the master device recognizes that the SDA 1002 is in a low voltage state. The slave device continues driving the last bit 1006 in compliance with timing specifications for the bus, and in order to permit the last bit 1006 to be sampled at a receiver. In conventional systems, the master device has no opportunity to drive SDA 1002 in order to transmit a repeated START condition.

According to certain aspects disclosed herein, the master device may be adapted to extend the clock following the last bit 1006 when the data byte 1030 is the Nth byte that ends in a low voltage state. The slave device may be adapted to release SDA 1002 after transmitting the last bit 1006 of the Nth sequentially transmitted byte that ends in a low voltage state. The master device may then transmit a repeated start condition. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N may determine worst case latency, and in many implementations, N is greater than 1.

In one example, N may be selected based on probabilities and may be configured to have a value of 4. In this example, it may be assumed that the voltage state of the last bit 1006 of each byte occurs at random and the probability of the last bit 1006 being in the low voltage state is 0.5, occurrence of a sequence of 2 bytes each with the last bit 1006 set to the low voltage state bits has a probability of 0.5×0.5=0.25, occurrence of a sequence of 3 bytes each with the last bit 1006 set to the low voltage state bits has a probability of 0.5×0.5×0.5=0.125, and occurrence of a sequence of 4 bytes each with the last bit 1006 set to the low voltage state bits has a probability of 0.5×0.5×0.5×0.5=0.0625. The technique disclosed herein may be seldom used (6.25% of the time) when N=4.

After detecting a sequence of N successive bytes whose last bit causes SDA 1002 to be in a low voltage state, the master device may initiate a failing edge 1034 on the pulse in SCL 1004 that corresponds to the last bit 1006 of the Nth byte. The master may then enable an open-drain class pull-up on SDA 1002. In one example, the open-drain class pull-up may include a resistor that is coupled to SDA 1002 through a switch controlled by the master device. After elapse of a period defined for clock-to-data turnaround and master-to-slave time of flight (e.g., signaling delay between master and slave), the slave releases SDA 1002 and causes its driver to enter a high-impedance mode. The master device causes the clock signal transmitted on SCL 1004 to enter an open-drain timing mode, in which SCL 1004 has an extended low period 1036 and an extended high period 1010. SDA 1002 rises to a high voltage level 1014 due to the pull-up by the open-drain class pull-up structure in the master driver, and while the output of the slave presents a high impedance to the bus.

SDA 1002 reaches the high voltage level 1014 while SCL 1004 is low. The master then drives SCL 1004 high. The extended high period 1010 of SCL 1004 provides sufficient delay for the master to generate a repeated start condition 1008 by pulling SDA 1002 low. During the next clock pulse 1028, the master may provide a stop condition 1012.

The mode of operation of the line driver in the slave device that is coupled to SDA 1002 is illustrated in the second timeline 1024. The line driver of the slave device is initially in an active mode 1032. When the slave device recognizes that the last bit 1006 of the Nth byte 1030 causes SDA 1002 to go to a LOW state, the slave device may cause its driver to enter high impedance mode 1020 to permit the master driver the option of takes control of SDA 1002. SDA 1002 may be pulled high by a termination resistor when the slave device enters high impedance mode 1020, and before the master device enters an active driving mode 1026. In one example, the termination resistor is an open-drain class pull-up resistor that is coupled to SDA 1002 through a switch controlled by the master device.

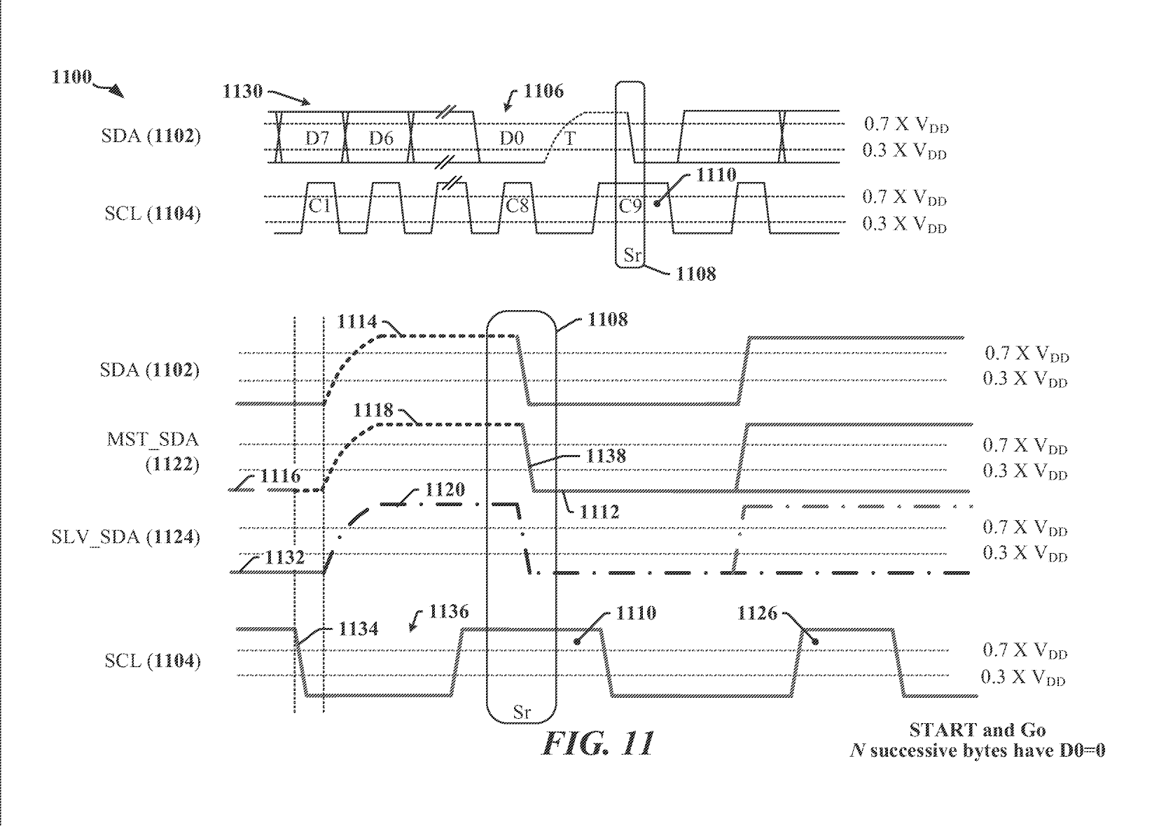

FIG. 11 includes timing diagrams 1100 that illustrate a fourth example in which a repeated START condition 1108 may be initiated early. In some instances, the repeated START condition 1108 may be asserted to terminate a transaction in which a slave device is transmitting data and may have data remaining to be transmitted. The example illustrated in FIG. 11 may relate to an instance when an exception is detected during transmission of a data frame or data byte 1130, and this example may be characterized as a “stop and go” example. The mode of operation of the line driver in the master device that is coupled to SDA 1102 is illustrated in the first timeline 1122, During transmission of a data byte 1130 by the slave device, the line driver in the master device is in a high-impedance mode 1116 and does not create any conflicts with the corresponding driver of the slave device. As the last bit 1106 of the data byte 1130 is being transmitted by the slave device, the master device recognizes that the SDA 1102 is in a low voltage state. The slave device continues driving the last bit 1106 in compliance with timing specifications for the bus, and in order to permit the last bit 1106 to be sampled at a receiver. In conventional systems, the master device has no opportunity to drive SDA 1102 in order to transmit a repeated start condition.

According to certain aspects disclosed herein, the master device may be adapted to extend the clock following the last bit 1106 when the data byte 1130 is the Nth sequentially-transmitted byte that ends in a low voltage state. The slave device may be adapted to release SDA 1102 after transmitting the last bit 1106 of the data byte that ends in a low voltage state. The master device may then transmit a repeated start condition. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N determines worst case latency.

After detecting a sequence of N successive bytes whose last bit causes SDA 1002 to be in a low voltage state, the master device may initiate a falling edge 1134 on the pulse in SCL 1104 that corresponds to the last bit 1106 of the Nth byte. The master may then enable an open-drain class pull-up on SDA 1102. In one example, the open-drain class pull-up may include a resistor that is coupled to SDA 1102 through a switch controlled by the master device. After elapse of a period defined for clock-to-data turnaround and master-to-slave time of flight (e.g., signaling delay between master and slave), the slave releases SDA 1102 and causes its driver to enter a high-impedance mode. The master device causes the clock signal transmitted on SCL 1104 to enter an open-drain timing mode, in which SCL 1104 has a pulse 1110 with an extended high period and an associated extended low period 1136. SDA 1102 rises to a high voltage level 1114 due to the pull-up by the open-drain class pull-up structure in the master driver, and while the output of the slave presents a high impedance to the bus. On the next clock pulse 1126, the master device may begin a new transmission on the serial bus.

The mode of operation of the line driver in the slave device that is coupled to SDA 1102 is illustrated in the second timeline 1124. The line driver of the slave device is initially in an active mode 1132. When the slave device recognizes that the last bit 1106 of the data byte 1130 causes SDA 1102 to go to a LOW state, the slave device may cause its driver to enter high impedance mode 1120 to permit the master driver the option of takes control of SDA 1102. SDA 1102 may be pulled high by a termination resistor when the slave device enters high impedance mode 1120, and before the master device enters an active driving mode 1112.

In one example, the master device enters the open-drain mode 1118 (with pull-up) after, or while transmitting a falling edge of SCL 1104. The master device may extend the duration of the voltage high state on SCL 1104 to comply with timing requirements associated with open-drain mode 1118. After a sufficient delay, which is enabled by the extended pulse 1110. the master device pulls SDA 1102 low, thereby providing a repeated START condition (repeated START condition 1108). The master device keeps the SDA 1102 in the low state for a period of time sufficient to comply with timing requirements associated with open-drain mode 1118. After the falling edge of the pulse 1110 the master device may drive SDA 1102 in accordance with the next data bit that needs to be transmitted. The master device may then provide a rising edge of the next clock pulse on SCL 1104.

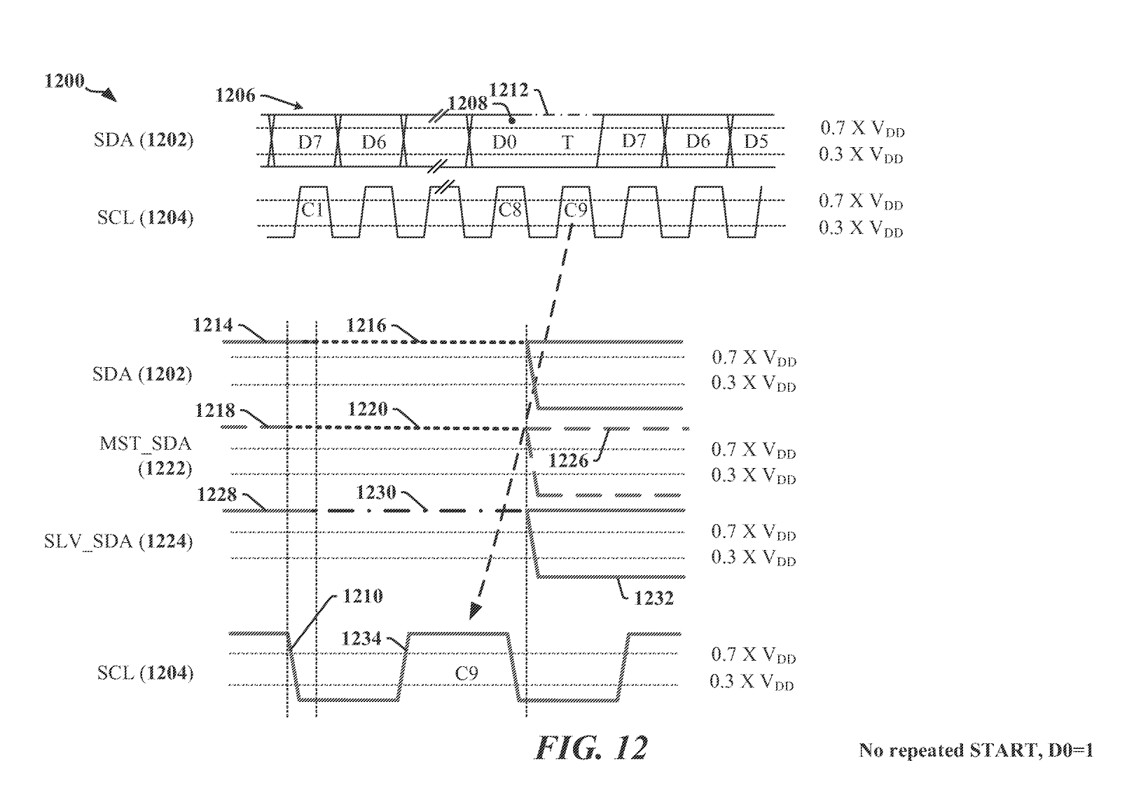

FIG. 12 includes timing diagrams 1200 that illustrate a first example of an operation in which a master device forgoes an opportunity to transmit a repeated START condition. This example may relate to an instance when the last bit of a data byte places SDA 1202 in a high voltage state. The mode of operation of the line driver in the master device that is coupled to SDA 1202 is illustrated in the first timeline 1222, During transmission of a data byte 1206 by the slave device, the line driver in the master device is in a high-impedance mode 1218 and does not create any conflicts with the corresponding driver of the slave device. As the last bit 1208 of the data byte 1206 is being transmitted by the slave device, the master device recognizes that the SDA 1202 is in a high voltage state. The master driver may cause the line driver of the master device to enter an open-drain mode 1230 (maintaining the high voltage state 1216 on SDA 1202) upon detection of the high voltage state corresponding to the last bit 1208 of the data byte 1206. In this example, the master device forgoes the opportunity to terminate the transmission.

The mode of operation of the line driver in the slave device that is coupled to SDA 1202 is illustrated in the second timeline 1224. The line driver of the slave device is initially in an active mode 1228 and actively drives 1214 SDA 1202. When the slave device recognizes that the last bit 1208 of the data byte 1206 has placed SDA 1202 in a high state, the slave device may cause its driver to enter high impedance mode 1220 to permit the master driver the option of takes control of SDA 1202. SDA 1202 may be pulled high by a termination resistor when the slave device enters high impedance mode 1220, and before the master device enters the high-impedance mode 1226. The master device forgoes the opportunity to terminate the transmission and the slave device may resume actively driving data 1232 on SDA 1202.

In one example, the, master device enters open-drain mode (with open-drain class pull-up) after, or while initiating a failing edge 1210 of SCL 1204. After a delay that includes a clock-to-data turnaround time specified by protocol and a master-to-slave time of flight (e.g., signaling delay between master and slave), the slave device releases SDA 1202 and enters a high-impedance output mode. SDA 1202 remains in the high voltage state 1216 due to the action of the open-drain class pull-up. The master device disables the open-drain class pull-up after a short time after SCL 1204 enters a low voltage state. The slave device starts driving SDA 1202 in push-pull mode after its clock-to-data turnaround time. The slave device may drive SDA 1202 while the open-drain class pull-up is still enabled. The read transaction continues with transmission of data 1232 in push-pull mode.

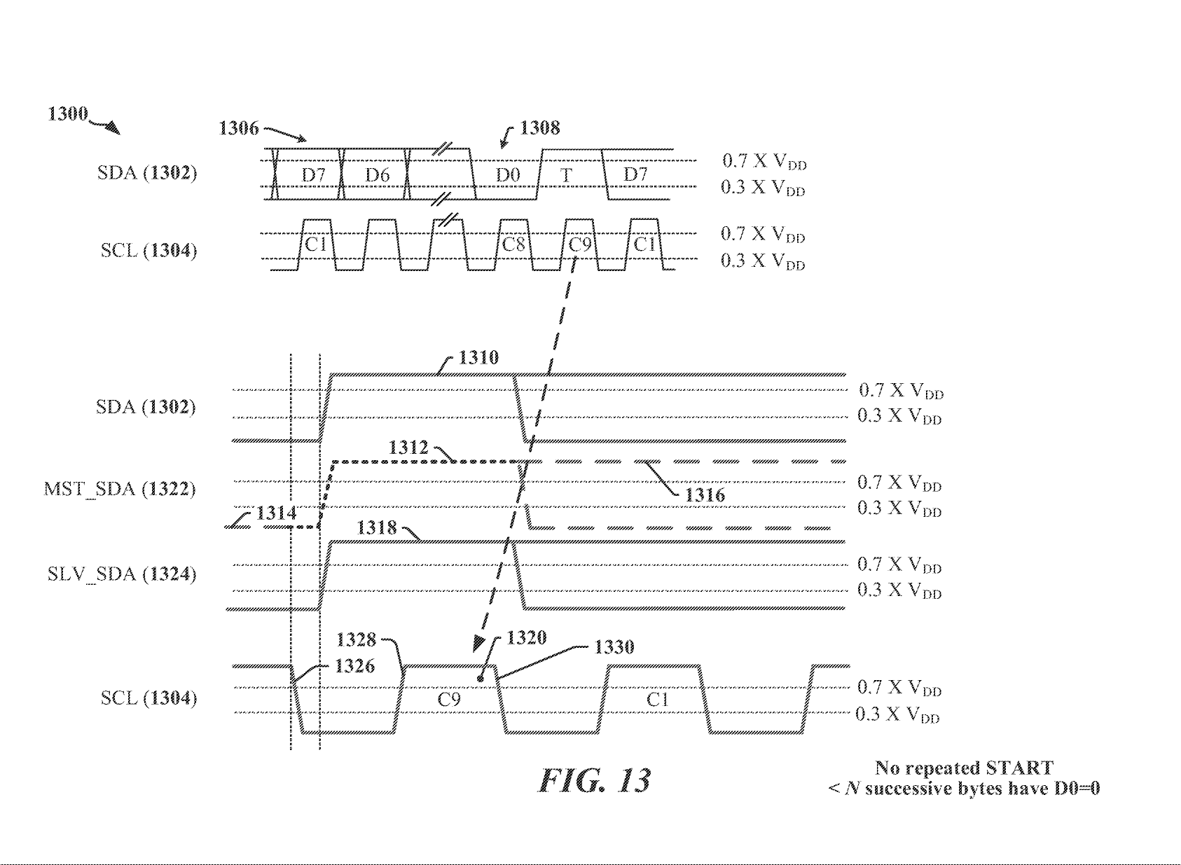

FIG. 13 includes timing diagrams 1300 that illustrate a second example of an operation in which a master device forgoes an opportunity to transmit a repeated START condition. The mode of operation of the line driver in the master device that is coupled to SDA 1302 is illustrated in the first timeline 1322. During transmission of a data byte 1306 by the slave device, the line driver in the master device is in a high-impedance mode 1314 and does not create any conflicts with the corresponding driver of the slave device. As the last bit 1308 of the data byte 1306 is being transmitted by the slave device, the master device recognizes that the SDA 1302 is in a low voltage state. The slave device continues driving the last bit 1308 in compliance with timing specifications for the bus, and in order to permit the last bit 1308 to be sampled at a receiver. In conventional systems, the master device has no opportunity to drive SDA 1302 in order to transmit a repeated start condition.

The slave device may be adapted according to certain aspects disclosed herein to release SDA 1302 after transmitting a last bit 1308 of the Nth byte that places SDA 1302 in a low voltage state. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N determines worst case latency.

In the example depicted in FIG. 13, the data byte 1306 is not the Nth sequentially-transmitted byte with a last bit 1308 of the Nth byte that places SDA 1302 in a low voltage state. In this example, the slave continues to drive SDA 1302. The master device may optionally enter an open-drain mode 1312 (with open-drain class pull-up). In some examples, the master device recognizes that the data byte 1306 is not the Nth sequentially-transmitted byte with a last bit 1308 of the Nth byte that places SDA 1302 in a low voltage state, and the master device remains in high-impedance mode 1314. In this example, the master device refrains from transmitting a repeated start condition.

The mode of operation of the line driver in the slave device that is coupled to SDA 1302 is illustrated in the second timeline 1324. The line driver of the slave device is initially in an active mode 1318. When the slave device recognizes that the data byte 1306 is not the Nth sequentially-transmitted byte with a last bit 1308 of the Nth byte that places SDA 1302 in a low voltage state, the slave device may continue driving SDA 1302.

In one example, the master device enters the open-drain mode 1312 (with open-drain class pull-up) after, or while transmitting a falling edge 1326 on SCL 1304. The master device may enable the open-drain class pull-up. After a delay that includes a clock-to-data turnaround time specified by protocol and a master-to-slave time of flight (e.g., signaling delay between master and slave), the slave device starts driving SDA 1302 to a high voltage state. The slave device may be designed to avoid timing issues. For example, certain characteristics of the slave device may be selected to avoid a delay that approaches 31 ns, at which point the Slave can miss the rising edge 1328 of the next pulse 1320 on SCL 1304. On the falling edge 1330 of the pulse 1320, the master device may disable the open-drain class pull-up. In some instances, the master device may disable the open-drain class pull-up at some time after the falling edge 1330 of the pulse 1320. The slave may then continue transmitting data in the READ transaction.

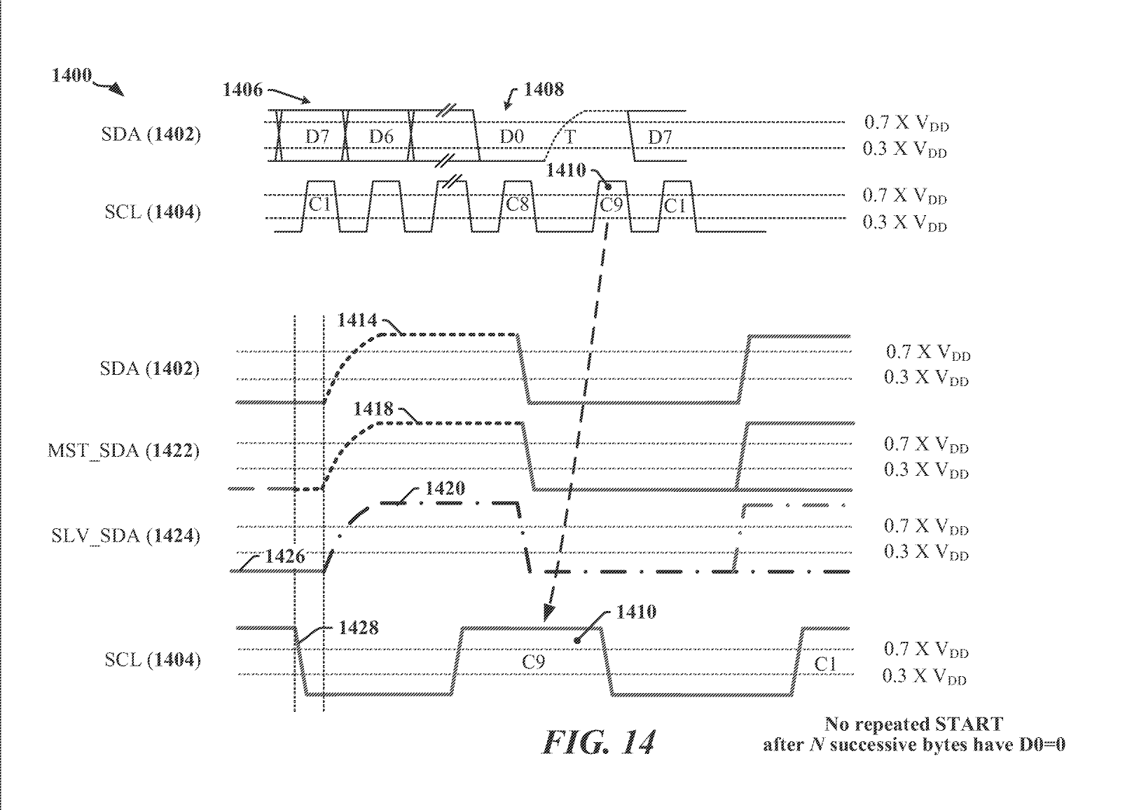

FIG. 14 includes timing diagrams 1400 that illustrate a third example of an operation in which a master device forgoes an opportunity to transmit a repeated START condition. The mode of operation of the line driver in the master device that is coupled to SDA 1402 is illustrated in the first timeline 1422. During transmission of a data byte 1406 by the slave device, the line driver in the master device is in a high-impedance mode 1414 and does not create any conflicts with the corresponding driver of the slave device. The save device is initially in an active mode 1426 and drives SDA 1402. As the last bit 1408 of the data byte 1406 is being transmitted by the slave device, the master device recognizes that the SDA 1402 is in a low voltage state. The slave device continues driving the last bit 1408 in compliance with timing specifications for the bus, and to permit the last bit 1408 to be sampled at a receiver. In conventional systems, the master device has no opportunity to drive a repeated start condition on SDA 1402.

The slave device may be adapted according to certain aspects disclosed herein to release SDA 1402 after transmitting a last bit 1408 of the Nth byte that places SDA 1402 in a low voltage state. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N determines worst case latency and can be any integer value.

In the example depicted in FIG. 14, the data byte 1406 is the Nth sequentially-transmitted byte with a last bit 1408 that places SDA 1402 in a low voltage state. The slave device may be adapted to release SDA 1402 after transmitting the last bit 1408 of the Nth data byte 1406. in this example, the slave enters a high-impedance mode 1420 to drive SDA 1402 providing the master device with the opportunity to transmit a repeated start condition. The master device may optionally enter an open-drain mode 1418 (with open-drain class pull-up). The master device recognizes that the data byte 1406 is the Nth sequentially-transmitted byte with a last bit 1408 of the Nth byte that places SDA 1402 in a low voltage state. In this example, the master device refrains from transmitting a repeated start condition and the master device remains in high-impedance mode 1414.

The mode of operation of the line driver in the slave device that is coupled to SDA 1402 is illustrated in the second timeline 1424. The line driver of the slave device is initially in an active mode 1426. The slave device may continue driving SDA 1402 when no repeated start condition is transmitted.

In one example, the master device enters the open-drain mode 1418 (with open-drain class pull-up) after, or while transmitting a falling edge 1428 on SCL 1404. The master device may enable the open-drain class pull-up. The clock transmitted on SCL 1404 may be kept on open-drain timing. After a delay that includes a clock-to-data turnaround time specified by protocol and a master-to-slave time of flight (e.g., signaling delay between master and slave), the slave device releases SDA 1402 and enters high-impedance mode 1420. SDA 1402 is pulled up by the open-drain class pull-up structure when the output of the slave device is in high-impedance mode 1420. SDA 1402 rises to the high voltage level. The master device records the high voltage state on SDA 1402 while SCL 1404 is stable at high voltage level. The master device consequently assesses that the slave device accepts the continuation of the READ transaction. The master device may then disable the open-drain class pull-up as it starts the failing edge of the pulse 1410 on SCL 1404. In some instances, the master device may disable the open-drain class pull-up after the falling edge of the pulse 1410 on SCL 1404 has been started. The slave device may enable its push-pull output and begin driving SDA 1402, after its clock-to-data turnaround time specified by protocol. In some instances, the slave device may drive SDA 1402 low while open-drain class pull-up is enabled. The READ transaction continues in push-pull mode.

Examples of Processing Circuits and Methods

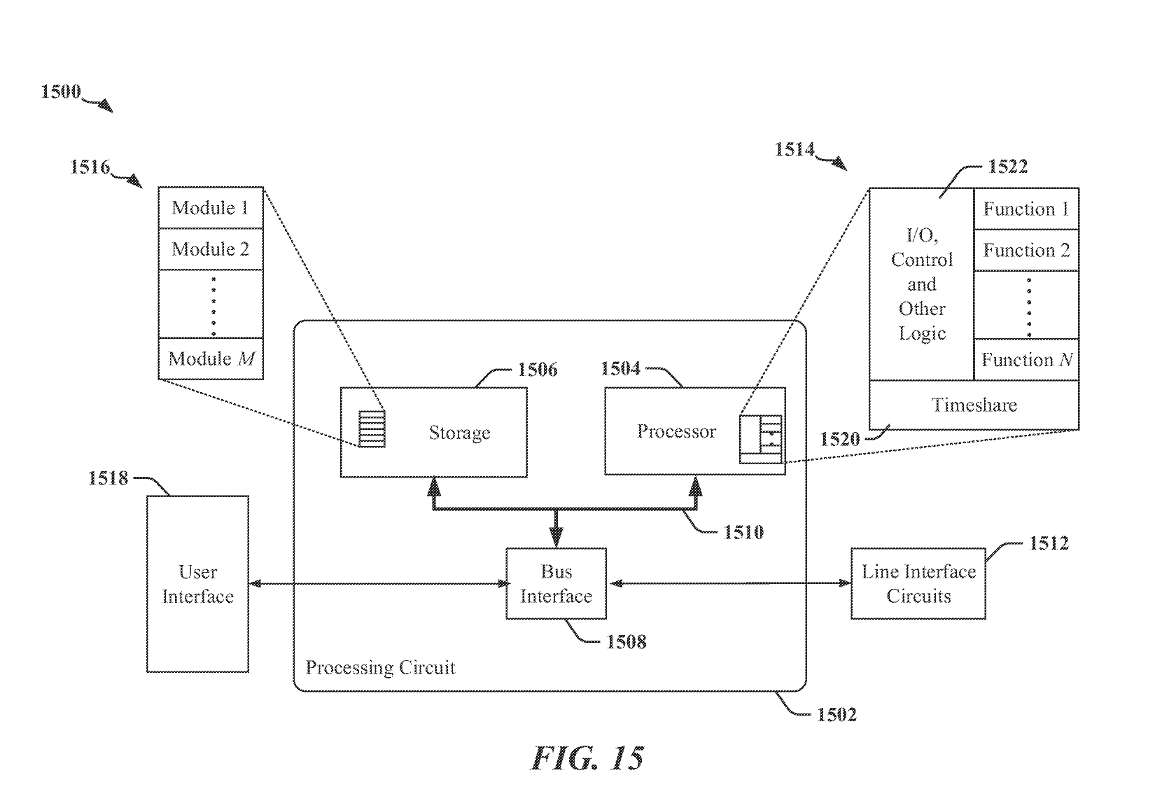

FIG. 15 is a diagram illustrating an example of a hardware implementation for an apparatus 1500 employing a processing circuit 1502 that may be configured to perform one or more functions disclosed herein. In accordance with various aspects of the disclosure, an element, or any portion of an element, or any combination of elements as disclosed herein may be implemented using the processing circuit 1502. The processing circuit 1502 may include one or more processors 1504 that are controlled by some combination of hardware and software modules. Examples of processors 1504 include microprocessors, microcontrollers, digital signal. processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1504 may include specialized processors that perform specific functions, and that may be configured, augmented or controlled by one of the software modules 1516. The one or more processors 1504 may be configured through a combination of software modules 1516 loaded during initialization, and further configured by loading or unloading one or more software modules 1516 during operation.

In the illustrated example, the processing circuit 1502. may be implemented with a bus architecture, represented generally by the bus 1510. The bus 1510 may include any number of interconnecting buses and bridges depending on the specific application of the processing circuit 1502 and the overall design constraints. The bus 1510 links together various circuits including the one or more processors 1504, and storage 1506. Storage 1506 may include memory devices and mass storage devices, and may be referred to herein as computer-readable media and/or processor-readable media. The bus 1510 may also link various other circuits such as timing sources, timers, peripherals, voltage regulators, and power management circuits. A bus interface 1508 may provide an interface between the bus 1510 and one or more transceivers 1512. A transceiver 1512 may be provided for each networking technology supported by the processing circuit. In some instances, multiple networking technologies may share some or all of the circuitry or processing modules found in a transceiver 1512. Each transceiver 1512 provides a means for communicating with various other apparatus over a transmission medium. Depending upon the nature of the apparatus 1500, a user interface 1518 (e.g., keypad, display, speaker, microphone, joystick) may also be provided, and may be communicatively coupled to the bus 1510 directly or through the bus interface 1508.

A processor 1504 may be responsible for managing the bus 1510 and for general processing that may include the execution of software stored in a computer-readable medium that may include the storage 1506. In this respect, the processing circuit 1502, including the processor 1504, may be used to implement any of the methods, functions and techniques disclosed herein. The storage 1506 may be used for storing data that is manipulated by the processor 1504 when executing software, and the software may be configured to implement any one of the methods disclosed herein.

One or more processors 1504 in the processing circuit 1502 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1506 or in an external computer-readable medium. The external computer-readable medium and/or storage 1506 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1506 may also include, by way of example, a carrier wave, a transmission line, and any other suitable medium for transmitting software and/or instructions that may be accessed and read by a computer. Computer-readable medium and/or the storage 1506 may reside in the processing circuit 1502, in the processor 1504, external to the processing circuit 1502, or be distributed across multiple entities including the processing circuit 1502. The computer-readable medium and/or storage 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1506 may maintain software maintained and/or organized in loadable code segments, modules, applications, programs, etc., which may be referred to herein as software modules 1516. Each of the software modules 1516 may include instructions and data that, when installed or loaded on the processing circuit 1502 and executed by the one or more processors 1504, contribute to a run-time image 1514 that controls the operation of the one or more processors 1504. When executed, certain instructions may cause the processing circuit 1502 to perform functions in accordance with certain methods, algorithms and processes described herein.

Some of the software modules 1516 may be loaded during initialization of the processing circuit 1502, and these software modules 1516 may configure the processing circuit 1502 to enable performance of the various functions disclosed herein. For example, some software modules 1516 may configure internal devices and/or logic circuits 1522 of the processor 1504, and may manage access to external devices such as the transceiver 1512, the bus interface 1508, the user interface 1518, timers, mathematical coprocessors, and so on. The software modules 1516 may include a control program and/or an operating system that interacts with interrupt handlers and device drivers, and that controls access to various resources provided by the processing circuit 1502. The resources may include memory, processing time, access to the transceiver 1512, the user interface 1518, and so on.

One or more processors 1504 of the processing circuit 1502 may be multifunctional, whereby some of the software modules 1516 are loaded and configured to perform different functions or different instances of the same function. The one or more processors 1504 may additionally be adapted to manage background tasks initiated in response to inputs from the user interface 1518, the transceiver 1512, and device drivers, for example. To support the performance of multiple functions, the one or more processors 1504 may be configured to provide a multitasking environment, whereby each of a plurality of functions is implemented as a set of tasks serviced by the one or more processors 1504 as needed or desired, in one example, the multitasking environment may be implemented using a timesharing program 1520 that passes control of a processor 1504 between different tasks, whereby each task returns control of the one or more processors 1504 to the timesharing program 1520 upon completion of any outstanding operations and/or in response to an input such as an interrupt. When a task has control of the one or more processors 1504, the processing circuit is effectively specialized for the purposes addressed by the function associated with the controlling task. The timesharing program 1520 may include an operating system, a main loop that transfers control on a round-robin basis, a function that allocates control of the one or more processors 1504 in accordance with a prioritization of the functions, and/or an interrupt driven main loop that responds to external events by providing control of the one or more processors 1504 to a handling function.

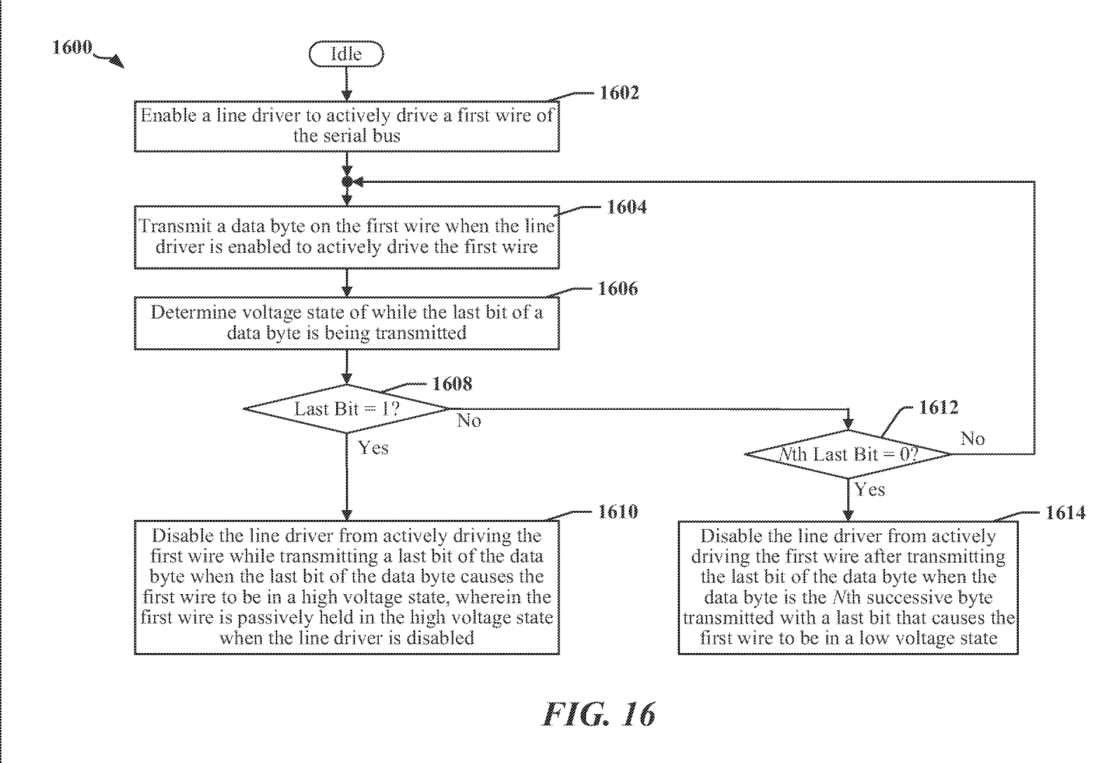

FIG. 16 is a flowchart 1600 of a method that may be performed at a slave device coupled to a serial bus and configured to communicate in accordance with one or more protocols, including an I3C protocol.

At block 1602, the slave device may enable a line driver to actively drive a first wire of the serial bus. The line driver may operate in a push-pull mode when enabled.

At block 1604, the slave device may transmit a data byte on the first wire when the line driver is enabled to actively drive the first wire.

At block 1606, the slave device may identify the state of a data line of the serial bus while the last bit of the data byte is being transmitted.

If at block 1608, the slave device determines that the data line of the serial bus is in a high voltage state (a logic 1) while the last bit of the data byte is being transmitted, then the method continues at block 1610. Otherwise, the method continues at block 1612.

At block 1610, the last bit of the data byte has caused the first wire to be in a high voltage state and the slave device may disable the line driver from actively driving the first wire while transmitting a last bit of the data byte. The first wire may be passively held in the high voltage state when the line driver is disabled.

At block 1612, the last bit of the data byte has caused the first wire to be in a low voltage state and the slave device may determine whether the data byte is preceded by N−1 sequentially-transmitted data bytes that have a last bit that causes the first wire to be in the low voltage state. When the data byte is the Nth sequentially-transmitted data byte that has a last bit that causes the first wire to be in a low voltage state, the method continues at block 1614. Otherwise, the method resumes at block 1604.

At block 1614, N sequentially-transmitted data bytes caused the first wire to be in a low voltage state, and the slave device may disable the line driver from actively driving the first wire after transmitting the last bit of the current data byte. The first wire may be passively held in the high voltage state when the line driver is disabled.

In one example, the line driver is disabled from actively driving the first wire after four sequentially-transmitted bytes each have a last bit that causes the first wire to be in the low voltage state. In another example, the line driver is disabled from actively driving the first wire after three sequentially-transmitted bytes each have a last bit that causes the first wire to be in the low voltage state. In another example, the line driver is disabled from actively driving the first wire after the sequentially-transmitted bytes each have a last bit that causes the first wire to be in the low voltage state. In another example, the line driver is disabled from actively driving the first wire after the first byte that has a last bit that causes the first wire to be in the low voltage state. In another example, N>5.

In some examples, disabling the line driver from actively driving the first wire may include causing an output of the line driver to present a high-impedance to the first wire. Disabling the line driver from actively driving the first wire may include configuring an output of the line driver for an open-drain mode of operation. Disabling the line driver from actively driving the first wire may include configuring an output of the line driver for a push-pull mode of operation.

In certain examples, the slave device may receive a command to enter an I3C mode of operation prior to enabling the line driver to actively drive the first wire. The slave device may exit the I3C mode of operation after disabling the line driver from actively driving the first wire. The slave device may identify an I2C repeated start condition in signaling on the serial bus after disabling the line driver from actively driving the first wire, re-enable the line driver to actively drive the first wire after identifying the I2C repeated start condition, and transmit a further data byte on the first wire after the line driver is re-enabled.

In one example, the data byte is transmitted while the serial bus is operated in accordance with an I3C protocol.

An apparatus may be adapted to operate as a slave device in accordance with the method illustrated in FIG. 16. The apparatus may include a line driver having an output configurable for a plurality of modes of operation, and a processing device. The processing device may be adapted to enable the output of the line driver to actively drive a first wire of the serial bus after an I2C start condition is detected on the serial bus, transmit a data byte on the first wire when the line driver is enabled, disable the output of the line driver while a last bit of the data byte is being transmitted and when the last bit of the data byte causes the first wire to be in a high voltage state, and disable the output of the line driver while wire after transmitting the last bit of the data byte when the data byte is the Nth sequentially-transmitted data byte that has a last bit that causes the first wire to be in a low voltage state. The first wire may be passively held in the high voltage state until transmission of the last bit of the data byte is completed. The first wire may be passively held by switchable resistance and/or using a keeper circuit. For example, the apparatus may include a pull-up resistor configured to hold the first wire in the high voltage state when the output of the line driver is disabled.

In some examples, the processing device is adapted to disable the line driver from actively driving the first wire after four sequentially-transmitted bytes each have a last bit that causes the first wire to be in the low voltage state. The apparatus may present a high impedance to the first wire when the output of the line driver is disabled. The line driver may be operable as an open-drain driver.

In one example, the processing device is adapted to identify an I2C repeated start condition in signaling on the serial bus after disabling the line driver, re-enable the line driver after identifying the I2C repeated start condition, and transmit a further data byte on the first wire after the line driver is re-enabled.

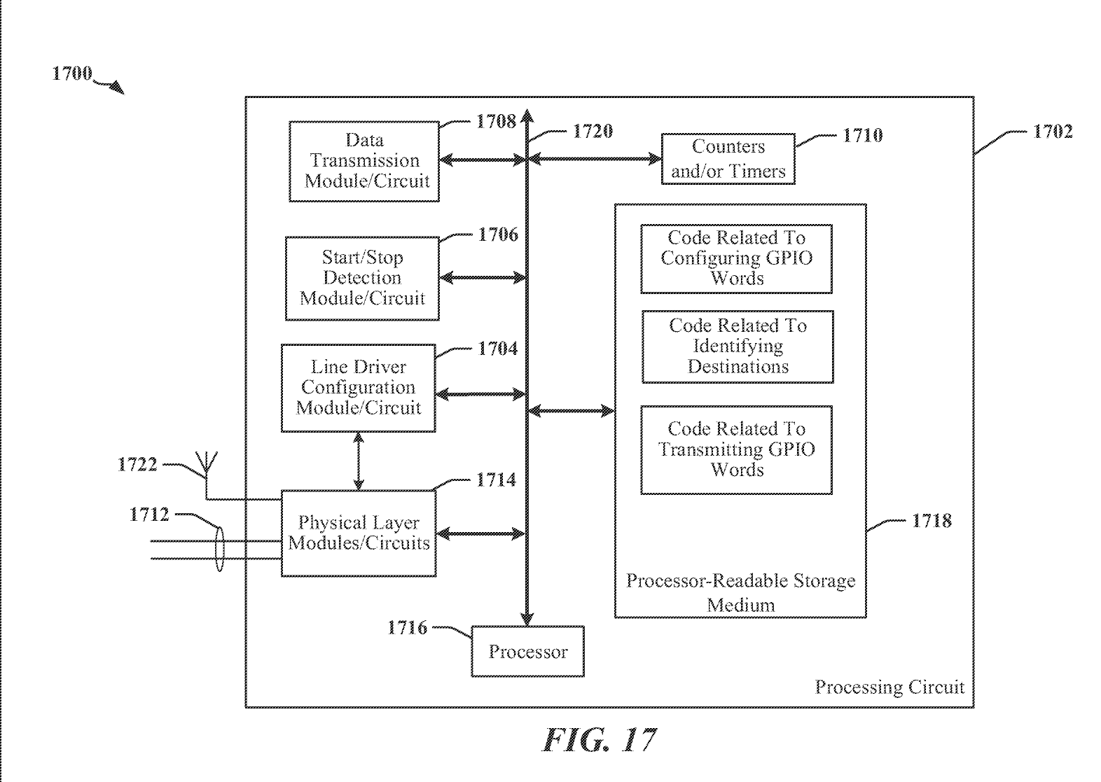

FIG. 17 is a diagram illustrating a simplified example of a hardware implementation for an apparatus 1700 employing a processing circuit 1702. The apparatus may implement, or be implemented in a slave device in accordance with certain aspects disclosed herein. The processing circuit typically has a controller or processor 1716 that may include one or more microprocessors, microcontrollers, digital signal processors, sequencers and/or state machines. The processing circuit 1702 may be implemented with a bus architecture, represented generally by the bus 1720. The bus 1720 may include any number of interconnecting buses and bridges depending on the specific application of the processing circuit 1702 and the overall design constraints. The bus 1720 links together various circuits including one or more processors and/or hardware modules, represented by the controller or processor 1716, the modules or circuits 1704, 1706 and 1708, and the processor-readable storage medium 1718. One or more physical layer circuits and/or modules 1714 may be provided to support communications over a communication link implemented using a multi-wire bus 1712, through an antenna 1722 (to a radio network for example), and so on. The bus 1720 may also link various other circuits such as timing sources 1710, peripherals, voltage regulators, and power management circuits, which are well known in the art, and therefore, will not be described any further.

The processor 1716 is responsible for general processing, including the execution of software, code and/or instructions stored on the processor-readable storage medium 1718. The processor-readable storage medium may include a non-transitory storage medium. The software, when executed by the processor 1716, causes the processing circuit 1702 to perform the various functions described supra for any particular apparatus. The processor-readable storage medium may be used for storing data that is manipulated by the processor 1716 when executing software. The processing circuit 1702 further includes at least one of the modules 1704, 1706 and 1708. The modules 1704, 1706 and 1708 may be software modules running in the processor 1716, resident/stored in the processor-readable storage medium 1718, one or more hardware modules coupled to the processor 1716, or some combination thereof. The modules 1704, 1706 and 1708 may include microcontroller instructions, state machine configuration parameters, or some combination thereof.

In one configuration, the apparatus 1700 includes a module and/or circuit 1706 configured to detect occurrence of start conditions and/or stop conditions, modules and/or circuits 1708, 1714 configured to manage data transmission over a multi-wire bus 1712, and modules and/or circuits 1704 configured to manage, control and configure line drivers in the physical layer circuits and/or modules 1714.

In one example, the apparatus 1700 may be adapted to operate as a slave device when coupled to a serial bus. The apparatus 1700 may include a line driver having an output configurable for a plurality of modes of operation, and a processor 1716. The processor 1716 may be adapted to enable the output of the line driver to actively drive a first wire of the serial bus after an I2C start condition is detected on the serial bus, transmit a data byte on the first wire when the line driver is enabled, and disable the output of the line driver while a last bit of the data byte is being transmitted and when the last bit of the data byte causes the first wire to be in a high voltage state. The first wire may passively held in the high voltage state until transmission of the last bit of the data byte is completed.

The apparatus 1700 may include a pull-up resistor configured to maintain the first wire in the high voltage state when the output of the line driver is disabled. The physical layer circuits and/or modules 1714 may present a high-impedance to the first wire when the output of the line driver is disabled. The physical layer circuits and/or modules 1714 may include configurable line drivers, including a line driver that is operable as a push-pull driver when the output of the line driver is enabled and/or as an open-drain driver.

The processor 1716 may be adapted to identify an I2C repeated start condition in signaling on the serial bus after disabling the line driver, re-enable the line driver after identifying the I2C repeated start condition, and transmit a further data byte on the first wire after the line driver is re-enabled.

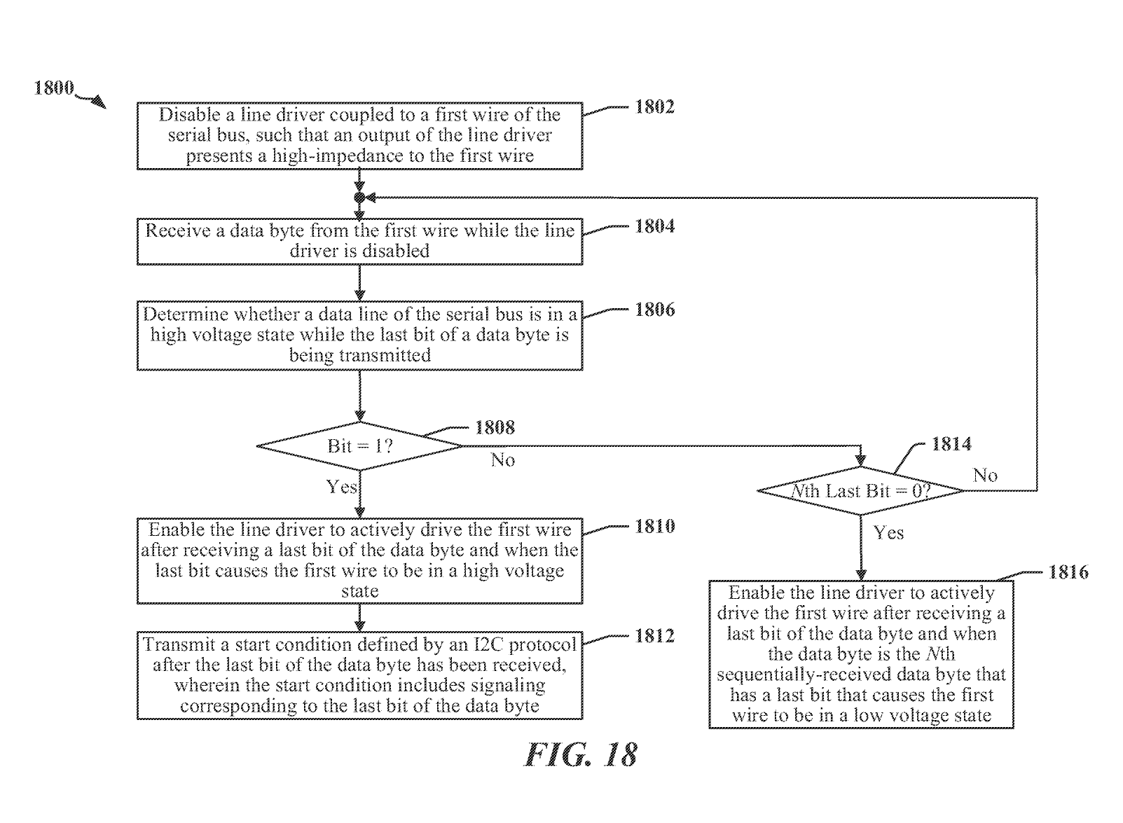

FIG. 18 is a flowchart 1800 of a method that may be performed at a master device coupled to a serial bus and configured to communicate in accordance with one or more protocols, including an I3C protocol.

At block 1802, the master device may disable a line driver coupled to a first wire of the serial bus, such that an output of the line driver presents a high-impedance to the first wire.

At block 1804, the master device may receive a data byte from the first wire while the line driver is disabled.

At block 1806, the master device may identify the voltage state of a data line of the serial bus while the last bit of the data byte is being transmitted.

If at block 1808, the master device determines that the data line of the serial bus is in a high voltage state (a logic 1) while the last bit of the data byte is being transmitted, then the method continues at block 1610. Otherwise, the method continues at block 1614.

At block 1810, the last bit of the data byte has caused the first wire to be in a high voltage state and the master device may enable the line driver to actively drive the first wire.

At block 1812, the master device may transmit a start condition defined by an I2C protocol after the line driver is enabled to actively drive the first wire.

At block 1814, the last bit of the data byte has caused the first wire to be in a low voltage state and the master device may determine whether the data byte is preceded by N−1 sequentially-transmitted data bytes that have a last bit that causes the first wire to be in the low voltage state. When the data byte is the Nth sequentially-transmitted data byte that has a last bit that causes the first wire to be in a low voltage state, the method continues at block 1816. Otherwise, the method resumes at block 1804.

At block 1816, N sequentially-transmitted data bytes have caused the first wire to be in a low voltage state, and the master device may enable the line driver to actively drive the first wire after receiving the last bit of the data byte.

In certain examples, the master device may extend timing of a clock signal transmitted on a second wire of the serial bus prior to enabling the line driver. Extending timing of the clock signal may include extending a clock pulse on a second wire of the serial bus. The clock pulse may be transmitted concurrently with the last bit of the data byte. The start condition includes a portion of the last bit of the data byte.

The line driver may be enabled after transmitting a sequence of four bytes that each have a last bit that causes the first wire to be in the low voltage state.

In one example, the master device may transmit a stop condition defined by the I2C protocol on the serial bus after transmitting the start condition. The master device may transmit a command that causes a slave device to enter an I3C mode of operation.

The data byte may be received while the serial bus is operated in accordance with an I3C protocol.

An apparatus may be adapted to operate as a master device in accordance with the method illustrated in FIG. 18. The apparatus may include a line driver having an output configurable for a plurality of modes of operation, and a processing device. The processing device may be adapted to transmit a first I2C start condition on the serial bus, configure the output of the line driver for a first mode of operation after the first I2C start condition has been transmitted on the serial bus, receive a data byte from the first wire when the output of the line driver is configured for the first mode of operation, configure the output of the line driver for a second mode of operation of while a last bit of the data byte causes the first wire to be in a high voltage state or after the last bit when the data byte is the Nth sequentially-received data byte that has a last bit that causes the first wire to be in a low voltage state, and transmit a second start condition. The second start condition may be a repeated start condition and includes signaling corresponding to the last bit of the data byte. The line driver may be disabled from actively driving a first wire of the serial bus when the output of the line driver is configured for the first mode of operation. The line driver may actively drive the first wire when the output of the line driver is configured for the second mode of operation. The first wire may be passively held in the high voltage state until the last bit of the data byte is received.

In some examples, the processing device is adapted to extend timing of a clock signal transmitted on a second wire of the serial bus prior to enabling the line driver. The processing device may be adapted to extend a clock pulse on a second wire of the serial bus. The clock pulse may be transmitted concurrently with the last bit of the data byte.

The line driver may be enabled after transmitting a sequence of four bytes that each have a last bit that causes the first wire to be in the low voltage state. An output of the line driver may operate as an open-drain driver in the second mode of operation

In one example, the start condition includes a portion of the last bit of the data byte.

The processing device may be adapted to transmit a stop condition defined by an I2C protocol on the serial bus after the second start condition. The processing device may be adapted to transmit a command that causes a slave device to transmit data in accordance with an I3C protocol.

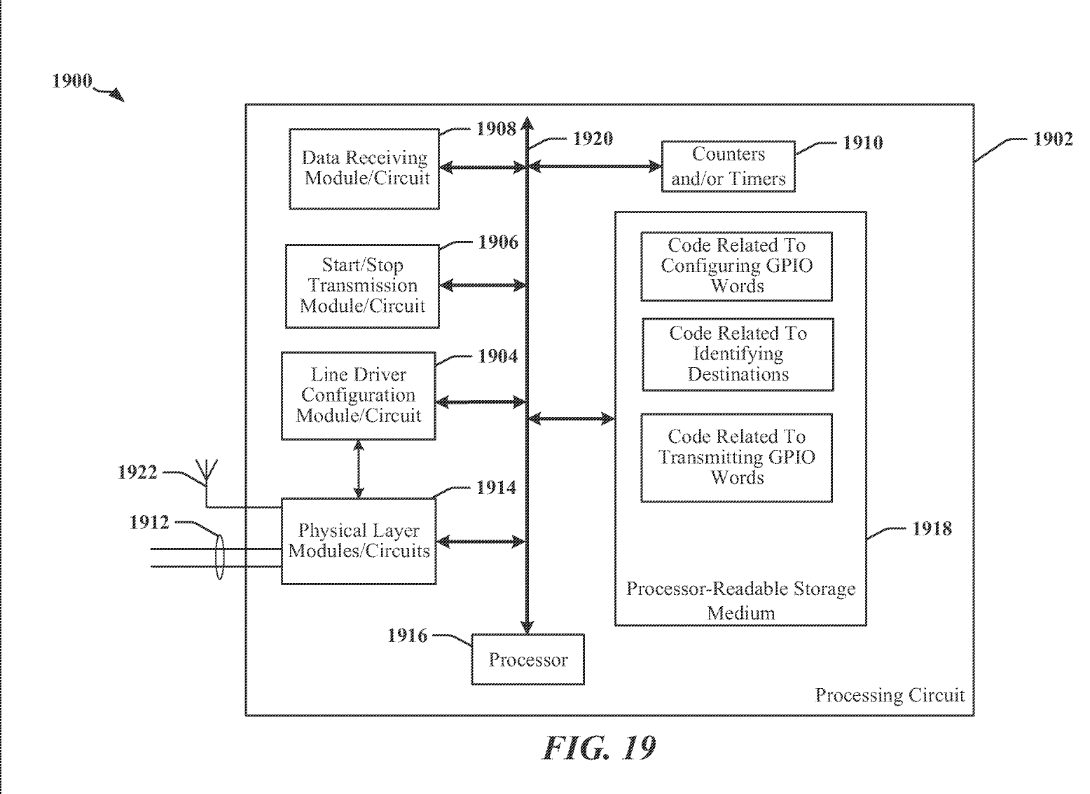

FIG. 19 is a diagram illustrating a simplified example of a hardware implementation for an apparatus 1900 employing a processing circuit 1902. The apparatus may implement a bridging circuit in accordance with certain aspects disclosed herein. The processing circuit typically has a controller or processor 1916 that may include one or more microprocessors, microcontrollers, digital signal processors, sequencers and/or state machines. The processing circuit 1902 may be implemented with a bus architecture, represented generally by the bus 1920. The bus 1920 may include any number of interconnecting buses and bridges depending on the specific application of the processing circuit 1902 and the overall design constraints. The bus 1920 links together various circuits including one or more processors and/or hardware modules, represented by the controller or processor 1916, the modules or circuits 1904, 1906 and 1908, and the processor-readable storage medium 1918. One or more physical layer circuits and/or modules 1914 may be provided to support communications over a communication link implemented using a multi-wire bus 1912, through an antenna 1922 (to a radio network for example), and so on. The bus 1920 may also link various other circuits such as timing sources 1910, peripherals, voltage regulators, and power management circuits, which are well known in the art, and therefore, will not be described any further.

The processor 1916 is responsible for general processing, including the execution of software, code and/or instructions stored on the processor-readable storage medium 1918. The processor-readable storage medium may include a non-transitory storage medium. The software, when executed by the processor 1916, causes the processing circuit 1902 to perform the various functions described supra for any particular apparatus. The processor-readable storage medium may be used for storing data that is manipulated by the processor 1916 when executing software. The processing circuit 1902 further includes at least one of the modules 1904, 1906 and 1908. The modules 1904, 1906 and 1908 may be software modules running in the processor 1916, resident/stored in the processor-readable storage medium 1918, one or more hardware modules coupled to the processor 1916, or some combination thereof. The modules 1904, 1906 and 1908 may include microcontroller instructions, state machine configuration parameters, or some combination thereof.

In one configuration, the apparatus 1900 includes a module and/or circuit 1906 configured to generate start conditions and/or stop conditions, modules and/or circuits 1908, 1914 configured to manage data reception from a multi-wire bus 1912, and modules and/or circuits 1904 configured to manage, control and configure line drivers in the physical layer circuits and/or modules 1714.

In one example, the apparatus 1900 may be adapted to operate as a master device when coupled to a serial bus. The apparatus 1900 may include a line driver having an output configurable for a plurality of modes of operation, and a processor 1916. The processor 1916 may be adapted to transmit a first I2C start condition on the serial bus, and configure the output of the line driver for a first mode of operation after the first I2C start condition has been transmitted on the serial bus. The line driver may be disabled from actively driving the first wire when the output of the line driver is configured for the first mode of operation. The processor 1916 may be adapted to receive a data byte from the first wire when the output of the line driver is configured for the first mode of operation, and configure the output of the line driver for a second mode of operation of while a last bit of the data byte causes the first wire to be in a high voltage state. The line driver may actively drive the first wire when the output of the line driver is configured for the second mode of operation. The processor 1916 may be adapted to transmit a second start condition. The second start condition may be a repeated start condition and may include signaling corresponding to the last bit of the data byte. The first wire may be passively held in the high voltage state until the last bit of the data byte is received.

In some instances, a clock pulse transmitted by the apparatus 1900 on a second wire of the serial bus is extended and included in the second start condition. The line driver may present a high-impedance to the serial bus in the first mode of operation. An output of the line driver may operate as a push-pull driver in the second mode of operation. An output of the line driver may operate as an open-drain driver in the second mode of operation.

The processor 1916 may be adapted to transmit an I2C stop condition on the serial bus after the second start condition. The processor 1916 may be adapted to transmit a command that causes a slave device to transmit data in accordance with an I3C protocol.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the scope consistent with the language claims, wherein reference to an element in the singular is not intended to mean “one and only one” unless specifically so stated, but rather “one or more.” Unless specifically stated otherwise, the, term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a slave device coupled to a serial bus, comprising:
enabling a line driver to actively drive a first wire of the serial bus;
transmitting a data byte on the first wire when the line driver is enabled to actively drive the first wire;
disabling the line driver from actively driving the first wire while transmitting a last bit of the data byte when the last bit of the data byte causes the first wire to be in a high voltage state; and
disabling the line driver from actively driving the first wire after transmitting the last bit of the data byte when the data byte is the Nth successive byte transmitted with a last bit that causes the first wire to be in a low voltage state,
wherein the first wire is passively held in the high voltage state when the line driver is disabled.

2. The method of claim 1, wherein is greater than 1.

3. The method of claim 1, wherein disabling the line driver from actively driving the first wire includes:
causing an output of the line driver to present a high impedance to the first wire.

4. The method of claim 1, wherein disabling the line driver from actively driving the first wire includes:
configuring an output of the line driver for an open-drain mode of operation.

5. The method of claim 1, wherein enabling the line driver to actively drive the first wire includes:
configuring an output of the line driver for a push-pull mode of operation.

6. The method of claim 1, and further comprising:
receiving a command to enter an I3C mode of operation prior to enabling the line driver to actively drive the first wire.

7. The method of claim 6, and further comprising:
exiting the I3C mode of operation after disabling the line driver from actively driving the first wire.

8. The method of claim 6, and further comprising:
identifying an I2C repeated start condition in signaling on the serial bus after disabling the line driver from actively driving the first wire;
re-enabling the line driver to actively drive the first wire after identifying the I2C repeated start condition; and
transmitting a further data byte on the first wire after the line driver is re-enabled.

9. The method of claim 1, wherein the data byte is transmitted while the serial bus is operated in accordance with an I3C protocol.

10. An apparatus adapted to operate as a slave device when coupled to a serial bus, the apparatus comprising:
a line driver having an output configurable for a plurality of modes of operation; and
a processing device adapted to:
enable the output of the line driver to actively drive a first wire of the serial bus after an inter-Integrated Circuit (I2C) start condition is detected on the serial bus;
transmit a data byte on the first wire when the line driver is enabled;
disable the output of the line driver while a last bit of the data byte is being transmitted and when the last bit of the data byte causes the first wire to be in a high voltage state; and
disable the line driver from actively driving the first wire after transmitting the last bit of the data byte when the data byte is the Nth successive byte transmitted with a last bit that causes the first wire to be in a low voltage state,
wherein the first wire is passively held in the high voltage state until transmission of the last bit of the data byte is completed.

11. The apparatus of claim 10, and further comprising:
a pull-up resistor configured to hold the first wire in the high voltage state when the output of the line driver is disabled.

12. The apparatus of claim 10, wherein N is greater than 1.

13. The apparatus of claim 10, wherein the apparatus presents a high impedance to the first wire when the output of the line driver is disabled.

14. The apparatus of claim 10, wherein the line driver is operable as an open-drain driver.

15. The apparatus of claim 10, wherein the processing device is adapted to:
identify an I2C repeated start condition in signaling on the serial bus after disabling the line driver;
re-enable the line driver after identifying the I2C repeated start condition; and
transmit a further data byte on the first wire after the line driver is re-enabled.

16. A method performed at a master device coupled to a serial bus, comprising:
disabling a line driver coupled to a first wire of the serial bus, such that an output of the line driver presents a high impedance to the first wire;
receiving a data byte from the first wire while the line driver is disabled;
enabling the line driver to actively drive the first wire after receiving a last bit of the data byte and when the last bit causes the first wire to be in a high voltage state or when the data byte is an Nth sequentially-received data byte that has a last bit that causes the first wire to be in a low voltage state; and
transmitting a start condition defined by an Inter-Integrated Circuit (I2C) protocol after the line driver is enabled to actively drive the first wire.

17. The method of claim 16, and further comprising:
extending timing of a clock signal transmitted on a second wire of the serial bus prior to enabling the line driver.

18. The method of claim 17, wherein extending timing of the clock signal comprises:
extending a clock pulse on a second wire of the serial bus, wherein the clock pulse is transmitted concurrently with the last bit of the data byte.

19. The method of claim 17, wherein the start condition comprises a portion of the last bit of the data byte.

20. The method of claim 16, wherein N is greater than 1.

21. The method of claim 16, and further comprising:
transmitting a stop condition defined by the I2C protocol on the serial bus after transmitting the start condition.

22. The method of claim 16, and further comprising:
transmitting a command that causes a slave device to enter an I3C mode of operation.

23. The method of claim 22, wherein the data byte is received while the serial bus is operated in accordance with an I3C protocol.

24. An apparatus adapted to operate as a master device, and comprising:
a line driver coupled to a serial bus, the line driver having an output configurable for a plurality of modes of operation; and
a processing device adapted to:
transmit a first Inter-integrated Circuit (I2C) start condition on the serial bus;
configure the output of the line driver for a first mode of operation after the first I2C start condition has been transmitted on the serial bus, wherein the line driver is disabled from actively driving a first wire of the serial bus when the output of the line driver is configured for the first mode of operation;
receive a data byte from the first wire when the output of the line driver is configured for the first mode of operation;
configure the output of the line driver for a second mode of operation of while a last bit of the data byte causes the first wire to be in a high voltage state or after the last bit when the data byte is an Nth sequentially-received data byte that has a last bit that causes the first wire to be in a low voltage state; and
transmit a second start condition, wherein the second start condition is a repeated start condition and includes signaling corresponding to the last bit of the data byte,
wherein the line driver actively drives the first wire when the output of the line driver is configured for the second mode of operation,
wherein the first wire is passively held in the high voltage state until the last bit of the data byte is received.

25. The apparatus of claim 24, wherein the processing device is adapted to:
extending timing of a clock signal transmitted on a second wire of the serial bus prior to enabling the line driver.

26. The apparatus of claim 25, wherein the processing device is adapted to:
extend a clock pulse on a second wire of the serial bus, wherein the clock pulse is transmitted concurrently with the last bit of the data byte.

27. The apparatus of claim 24, wherein N is greater than 1.

28. The apparatus of claim 24, wherein the start condition comprises a portion of the last bit of the data byte.

29. The apparatus of claim 24, wherein the processing device is adapted to:
transmit a stop condition defined by an Inter-Integrated Circuit (I2C) protocol on the serial bus after the second start condition.

30. The apparatus of claim 24, wherein the processing device is adapted to:
transmit a command that causes a slave device to transmit data in accordance with an I3C protocol.
